(19) United States
(12) Patent Application Publication
(10) Pub. No.: US 2001/0025091 A1
(43) Pub. Date: Sep. 27, 2001

(54) Ethylene terpolymers and process for their preparation

(75) Inventors: Ioan Tincul, Sasolburg (ZA); Dawid Johannes Joubert, Sasolburg (ZA); Desmond Austin Young, Vanderbijlpark (ZA)

Correspondence Address: Ladas & Parry, 26 West 61st Street, New York, NY, 10023, US

(73) Assignee: SASOL TECHNOLOGY (PROPRIETARY) LIMITED

(21) Appl. No.: 09/761,633

(22) Filed: Mar. 12, 2001

Related U.S. Application Data
(63) Continuation of application No. PCT/IB99/01293, filed on Jul. 19, 1999.

(30) Foreign Application Priority Data
Jul. 20, 1998 (ZA) 98/6441

(51) Int. Cl. C08F 4/44

(52) U.S. Cl. 526/124.3; 526/904; 526/348.2; 526/348.3; 526/348.5; 526/348.6

(57) ABSTRACT

The invention provides a polymer of ethylene as a first component or monomer, with a branched olefin as a second component or monomer, and at least one different olefin as a third component or monomer. The olefins can be obtained from a Fischer-Tropsch process.

THIS INVENTION relates to polymerization. It relates in particular to polymers of ethylene as a first monomer, with second and third monomers, and to a process for producing such polymers.

Broadly, according to the invention, there is provided a polymer of ethylene as a first component or monomer, with a branched olefin as a second component or monomer, and at least one different olefin as a third component or monomer.

The olefinic monomers employed in the polymers according to this invention may be Fischer-Tropsch derived, ie may be obtained from the so-called Fischer-Tropsch process; however any other polymerization grade olefin c monomers obtained from other processes may be employed instead of one or more of the Fischer-Tropsch derived olefinic monomers. Thus, a combination of Fischer-Tropsch derived, and non-Fischer-Tropsch derived monomers can be used.

By ‘Fischer-Tropsch derived’ in respect of the monomers or components is meant monomers or components obtained by is reacting a synthesis gas comprising carbon monoxide and hydrogen in the presence of a suitable Fischer-Tropsch catalyst, normally a cobalt, iron, or cobalt/iron Fischer-Tropsch catalyst, at elevated temperature n a suitable reactor, which is normally a fixed or slurry bed reactor, thereby to obtain a range of products, including monomers or components suitable for use in the polymers of this invention. The products from the Fischer-Tropsch reaction must then usually be worked up to obtain the individual products such as the monomers or components suitable for use in the polymers of the present invention.

Thus, the polymers according to this invention may be polymers of ethylene as the first monomer, with at least one branched olefin as the second monomer and a third olefin as the third monomer, and with these olefins being obtained from a Fischer-Tropsch process. They may instead be polymers of any other polymerization grade olefinic monomers obtained from other processes or they may be polymers of combinations of Fischer-Tropsch derived and non-Fischer-Tropsch derived olefinic monomers.

The inventors surprisingly discovered that when the olefinic monomers employed in catalyzed polymerization as the second monomer or component, eg a first branched alpha olefin, and/or as the third monomer or component, eg a linear alpha olefin or a second branched alpha olefin, are obtained from the Fisher-Tropsch process, the resultant polymers have very large domains of fundamental and/or application properties, and may be superior in some of these properties to those of polymers in which all the monomers have been obtained by conventional methods. The inventors believe that this unexpected behaviour is due to very small amounts of other olefinic components present and which until now have been regarded as impurities. These other olefinic components may be other hydrocarbons bearing one or more double bonds, whether linear, branched or aromatic, with the exception of those which poison the catalyst to the extent that it no longer polymerizes the monomers. The inventors further believe that these components may sometimes function to change the polydispersity in the polymers obtained according to this invention, thus improving the processability of these polymers. These components may selectively and/or partially and/or temporarily poison some active sites of the catalyst, thus retarding or enhancing the rates of different reactions, such as monomer insertion and/or propagation and/or transfer and/or termination, thereby changing the distribution of the comonomers in the polymer chain and/or the content level of the individual comonomers in the polymer and/or the length of branching of the polymer backbone and/or the molecular weight of the polymer and/or its molecular weight distribution, and/or its morphology, with any one or more of these being reflected in unexpected application properties of the resultant polymers.

However, the inventors also discovered that, for practical applications when the olefinic monomers employed in the polymerization as the second monomer component, eg a first branched alpha olefin, and/or as the third monomer component, eg a linear alpha olefin or a second branched alpha olefin are obtained from the Fisher-Tropsch process, the proportion of the other olefinic components referred to hereinbefore is preferably within particular limits.

Thus, the amount of these other olefinic components present in the second monomer component, eg in a first branched alpha olefin, and/or in the third monomer component, eg in a linear alpha olefin or the second branched alpha olefin when obtained from the Fisher-Tropsch process may be from 0,002% to 2%, more preferably from 0,02% to 2%, and most preferably from 0,2% to 2%, based on the total mass of the monomer, ie given on a mass or weight basis. In the case of the second monomer, any of the third monomer present therein, eg a linear alpha olefin or a second branched alpha olefin, does not constitute part of the other olefinic components hereinbefore referred to. Similarly, in the case of the third monomer, any of the second monomer present therein, eg a first branched alpha olefin, does not constitute part of the other olefinic components. In respect of any such constituents present in the second and third monomers, these form part of the total amounts or proportions of the respective components or monomers which partake in the polymerization reaction to obtain the polymers according to the invention. It is also to be noted that in particular cases the total amount of the other olefinic components in one of the comonomers may be increased above the limits hereinbefore set out, with a comcommittent decrease in the total amount of other olefinic components in the other comonomer. This increase/decrease mechanism may follow an additive rule, eg the amount by which the other olefinic components are increased in one monomer may be the same amount by which the other olefin components are decreased in the other monomer employed in the polymerization, provided that the total remains constant. However, the presence of the other is olefinic components in proportions in excess of the limits given hereinbefore, in certain cases, is not excluded.

The ethylene may also be obtained from the Fischer-Tropsch process. However, due to the process of separation and purification involved in obtaining the Fischer-Tropsch derived ethylene, polymers containing Fischer-Tropsch derived ethylene may, in certain cases, not show any difference to polymers containing ethylene obtained from conventional processes.

Additionally, when the third monomer or component comprises propylene or 1-butene as hereinafter described and has been obtained from the Fischer-Tropsch process, it may first have been worked up such that it is substantially identical to other commercially available propylene or 1-butene, in which case polymers according to the invention and which are derived from such propylene or 1-butene may not show any difference to polymers according to the invention and which have been derived from other commercially available propylene or 1-butene.

More specifically, according to a first aspect of the invention, there is provided a polymer of ethylene as a first component or monomer, with a branched alpha olefin as a second component or monomer and at least one different alpha olefin as a third component or monomer, and wherein at least one of the co-monomers is Fischer-Tropsch derived.

In other words, according to the first aspect of the invention, there is provided a polymer which is the reaction product of ethylene as a first component or monomer with a branched alpha olefin as a second component or monomer and at least one different alpha olefin as a third component or monomer, and wherein at least one of the co-monomers is Fischer-Tropsch derived.

Further, according to the first aspect of the invention, there is provided a terpolymer of ethylene as a first component or monomer with a branched alpha olefin as a second component or monomer and at least one different alpha olefin as a third component or monomer, and wherein at least one of the co-monomers is Fischer-Tropsch derived.

The third component may comprise a linear alpha olefin or a second branched alpha olefin, which is different to the branched alpha olefin of the second component.

The ratio of the molar proportion of the ethylene to the sum of the molar proportions of the branched alpha olefin and the different alpha olefin may be from 99,9:0,1 to 80:20. The preferred ratio of the molar proportion of the ethylene to the sum of the molar proportions of the branched alpha olefin and the different alpha olefin is from 99,9:0,1 to 90:10. The most preferred ratio of the molar proportion of the ethylene to the sum of the molar proportions of the branched alpha olefin and the different alpha olefin is from 99,9:0,1 to 95:5.

The ratio of the molar proportion of the branched alpha olefin to that of the different alpha olefin may be from 0,1:99,9 to 99,9:0,1. The preferred ratio of the molar proportion of the branched alpha olefin to that of the different alpha olefin is from 1:99 to 99:1. The most preferred ratio of the molar proportion of the branched alpha olefin to that of the different alpha olefin is from 2:98 and 98:2.

In particular, the polymer may be that obtained by reacting ethylene, the branched alpha olefin and the different alpha olefin in one or more reaction zones, while maintaining in the reaction zone(s) a pressure in the range between atmospheric pressure and 5000 kg/cm² and a temperature between ambient and 300° C., in the presence of a suitable catalyst or catalyst system.

The inventors have discovered that the known art of copolymerization of ethylene with different alpha olefins, or terpolymerization of ethylene with at least two linear alpha olefins, can not be applied or extrapolated to the polymerization of ethylene with a particular branched alpha olefin as the second component and a particular linear third alpha olefin as the third component, in accordance with the invention. On the contrary, the inventors have surprisingly discovered that terpolymers in accordance with the invention have unexpected domains of fundamental and/or application properties, so that the terpolymers can be used in a large field of applications. The inventors have also surprisingly found that terpolymers of ethylene with a branched alpha olefin and a third linear alpha olefin according to this invention may have the same domain of density and while having the same domain of melt flow index, may, however, have different and surprising application properties.

More particularly, the inventors have surprisingly found that in the broad family of the terpolymers of ethylene with a branched alpha olefin as the second component and a linear alpha olefin as the third component, in accordance with this invention, there are particular families having even more surprising application properties. For example, the inventors have found that a terpolymer of ethylene obtained by the terpolymerization of ethylene, a linear alpha olefin and a branched alpha olefin having a total number of carbon atoms equal to six, differs unexpectedly from a terpolymer of ethylene obtained by the terpolymerization of ethylene with a linear alpha olefin and a branched alpha olefin having a total number of carbon atoms in excess of six as well as from a terpolymer of ethylene obtained by the terpolymerization of ethylene with a linear alpha olefin and with a branched alpha olefin with a total number of carbon atoms fewer than six.

The inventors have even more surprisingly found that in the three families of terpolymers of ethylene with a branched alpha olefin as the second component and a linear alpha olefin as the third component in accordance with this invention, terpolymers obtained by polymerization of ethylene, a linear alpha olefin and a branched alpha olefin having a total number of carbon atoms equal to six, as a first family; terpolymers of ethylene obtained by the polymerization of ethylene with a linear alpha olefin and with a branched alpha olefin having a total number of carbon atoms in excess of six, as a second family; and terpolymers of ethylene obtained by the polymerization of ethylene with a linear alpha olefin and with a branched alpha olefin having a total number of carbon atoms fewer than six, as a third family, there can be found particular distinguishable groups of polymers with a large range of unexpected properties dependent on the different linear alpha olefins, having different numbers of total carbon atoms, used. The properties of the individual members of these groups are not proportional to the number of carbons of the linear olefinic hydrocarbon as would be expected.

The properties of the terpolymers in each family and subfamily group are determined mainly by the ratio of the proportion of ethylene to the sum of the proportions of the branched alpha olefin and the further linear alpha olefin used in the terpolymerization reaction to form the terpolymer according to this invention, and by the ratio of the proportion of the branched alpha olefin to that of the linear-alpha olefin used in the terpolymerization reaction. In other words, the properties of the terpolymer, based on the ethylene: sum of the total comonomer content, on a molar basis, can be varied by varying the ratio of the proportion of the branched alpha olefin to that of the linear alpha olefin. In this way, a large range of particular terpolymers can be obtained, having a large range of application properties controlled between certain limits. The resultant terpolymers are suitable for improved application in the main processing fields. Typical applications of the terpolymer include extrusions, blow moulding and injection moulding.

Thus, according to a second aspect of the invention, there is provided a polymer of ethylene as a first component or monomer with at least one branched alpha olefin as a second component or monomer and at least one linear alpha olefin as a third component or monomer.

In other words, according to the second aspect of the invention, there is provided a polymer which is the reaction product of ethylene as a first component or monomer with at least one branched alpha olefin as a second component or monomer and at least one linear alpha olefin as a third component or monomer.

Further, according to the second aspect of the invention, there is provided a terpolymer of ethylene as a first component or monomer with at least one branched alpha olefin as a second component or monomer and at least one linear alpha olefin as a third component or monomer.

The ratio of the molar proportion of the ethylene to the sum of the molar proportions of the branched alpha olefin and the further linear alpha olefin may be from 99,9:0,1 to 80:20. The preferred ratio of the molar proportion of the ethylene to the sum of the molar proportions of the branched alpha olefin and the further linear alpha olefin is from 99,9:0,1 to 90:10. The most preferred ratio of the molar proportion of the ethylene to the sum of the molar proportions of the branched alpha olefin and the further linear alpha olefin is from 99:9:0,1 to 95:5.

The ratio of the molar proportion of the branched alpha olefin to that of the further linear alpha olefin may be from 0,1:99,9 to 99,9:0,1. The preferred ratio of the molar proportion of the branched alpha olefin to that of the further linear alpha olefin is from 1:99 to 99:1. The most preferred ratio of the molar proportion of the branched alpha olefin to the further linear alpha olefin is from 2:98 to 98:2.

In particular, the polymer according to the second aspect of the invention may be that obtained by reacting ethylene, the branched alpha olefin and the third linear alpha olefin in one or more reaction zones, while maintaining in the reaction zone(s) a pressure in the range between atmospheric pressure and 5000 kg/cm² and a temperature between ambient and 300° C., in the presence of a suitable catalyst or catalyst system.

The polymer according to the second aspect of the invention may have the following properties:

a) a melt flow rate as measured according to ASTM D 1238 in the range of 0,01 to about 100 g/10 min; and/or

b) a density as measured according to ASTM D 1505 in the range of about 0,835 to about 0,950; and/or

c) when its hardness is plotted against its density, it conforms to the following equation:

545,4ρ−463,64<H<545,4ρ−447,3

where ρ is the density of the polymer as measured above and H is its hardness as measured according to ASTM D 2240, with the domain for which the equation is valid being:

0<H<60

and

0,82<ρ<0,96

In a first embodiment of the second aspect of the invention, the polymer may be a terpolymer of ethylene, 4-methyl-1-pentene as the branched alpha olefin, and the linear alpha olefin.

The linear alpha olefin may be any linear alpha olefin having a total number of carbon atoms between 3 and 10, leading thus to subgroups of terpolymers with differing third or linear alpha olefin content and differing application properties. Surprisingly, the inventors have found that there is no mathematical relationship between the number of carbon atoms of the linear alpha olefin and the properties of the resultant polymer.

The terpolymer of ethylene with 4-methyl-1-pentene as the second component and the linear alpha olefin as the third component may have the following properties:

a) a melt flow rate as measured according to ASTM D 1238 in the range of 0,01 to about 100 g/10 min; and/or

b) a density as measured according to ASTM D 1505 in the range of 0,890 to about 0,950; and/or

c) when its tensile strength at yield is plotted against its density, it conforms to the following equation:

σ>111,1ρ−93,3

where ρ is the density of the terpolymer as measured above and σ is the tensile strength at yield as measured according to ASTM D 638 M, with the domain for which the equation is valid being:

σ>0

and

0,84<ρ<0,96;

and/or

d) when its modulus is plotted against its density, it conforms to the following equation:

E>3636ρ−3090,9

where ρ is the density of the terpolymer as measured above and E is its modulus as measured according to ASTM D 638 M, with the domain for which the equation is valid being:

E>0

and

0,85<ρ<0,96.

In a first version of the first embodiment of the second aspect of the invention, the terpolymer may be that obtained by the reaction of ethylene with 4-methyl-1-pentene and propylene.

In particular, the terpolymer of ethylene, 4-methyl-1-pentene and propylene may have the following properties:

| Hardness | = | 23 and/or |
|---|---|---|
| Impact Strength (kJ/m2) | = | 17.6 and/or |
| Yield Strength (MPa) | = | 5.0 and/or |
| Elongation at Yield (%) | = | 76 and/or |
| Young's Modulus (MPa) | = | 142 |

In another particular case it may have the following properties:

| Hardness | > | 23 and/or |
|---|---|---|
| Impact Strength (kJ/m2) | > | 17.6 and/or |
| Yield Strength (MPa) | > | 5.0 and/or |
| Elongation at Yield (%) | > | 76 and/or |
| Young's Modulus (MPa) | > | 142 |

In still another particular case it may have the following properties:

| Hardness | < | 23 and/or |
|---|---|---|
| Impact Strength (kJ/m2) | < | 17.6 and/or |
| Yield Strength (MPa) | < | 5.0 and/or |
| Elongation at Yield (%) | < | 76 and/or |
| Young's Modulus (MPa) | < | 142 |

In a second version of the first embodiment of the second aspect of the invention, the terpolymer may be that obtained by the reaction of ethylene with 4-methyl-1-pentene and 1-butene.

In particular, the terpolymer of ethylene, 4-methyl-1-pentene and 1-butene may have the following properties:

| Hardness | = | 39 and/or |
|---|---|---|
| Impact Strength (kJ/m2) | = | 34.1 and/or |
| Yield Strength (MPa) | = | 8.4 and/or |
| Elongation at Yield (%) | = | 56 and/or |
| Young's Modulus (MPa) | = | 269 |

In another particular case it may have the following properties:

| Hardness | > | 39 and/or |
|---|---|---|
| Impact Strength (kJ/m2) | > | 34.1 and/or |
| Yield Strength (MPa) | > | 8.4 and/or |
| Elongation at Yield (%) | > | 56 and/or |
| Young's Modulus (MPa) | > | 269 |

In still another particular case it may have the following properties:

| Hardness | < | 39 and/or |
|---|---|---|
| Impact Strength (kJ/m2) | < | 34.1 and/or |
| Yield Strength (MPa) | < | 8.4 and/or |
| Elongation at Yield (%) | < | 56 and/or |
| Young's Modulus (MPa) | < | 269 |

In a third version of the first embodiment of the second aspect of the invention, the terpolymer may be that obtained by the reaction of ethylene, 4-methyl-1-pentene and 1-pentene.

In particular, the terpolymer of ethylene, 4-methyl-1-pentene and 1-pentene may have the following properties:

| Hardness | = | 46 and/or |
|---|---|---|
| Impact Strength (kJ/m2) | = | 42 and/or |
| Yield Strength (MPa) | = | 11.3 and/or |
| Elongation at Yield (%) | = | 79 and/or |
| Young's Modulus (MPa) | = | 324 |

In another particular case it may have the following properties:

| Hardness | > | 46 and/or |
|---|---|---|
| Impact Strength (kJ/m2) | > | 42 and/or |
| Yield Strength (MPa) | > | 11.3 and/or |
| Elongation at Yield (%) | > | 79 and/or |
| Young's Modulus (MPa) | > | 324 |

In still another particular case it may have the following properties:

| | | |
|---|---|---|
| Hardness | < | 46 and/or |
| Impact Strength (kJ/m2) | < | 42 and/or |
| Yield Strength (MPa) | < | 11.3 and/or |
| Elongation at Yield (%) | < | 79 and/or |
| Young's Modulus (MPa) | < | 324 and/or |

In a fourth version of the first embodiment of the second aspect of the invention, the terpolymer may be that obtained by the reaction of ethylene, 4-methyl-1-pentene and 1-hexene.

In particular, the terpolymer of ethylene, 4-methyl-1-pentene and 1-hexene may have the following properties:

| Hardness | = | 42 and/or |
|---|---|---|
| Impact Strength (kJ/m2) | = | 31.8 and/or |
| Yield Strength (MPa) | = | 8.8 and/or |
| Elongation at Yield (%) | = | 47 and/or |
| Young's Modulus (MPa) | = | 352 |

In another particular case it may have the following properties:

| Hardness > | 42 and/or |
|---|---|
| Impact Strength (kJ/m2) > | 31.8 and/or |
| Yield Strength (MPa) > | 8.8 and/or |
| Elongation at Yield (%) > | 47 and/or |
| Young′s Modulus (MPa) > | 352 |

In still another particular case it may have the following properties:

| Hardness < | 42 and/or |
|---|---|
| Impact Strength (kJ/m2) < | 31.8 and/or |
| Yield Strength (MPa) < | 8.8 and/or |
| Elongation at Yield (%) < | 47 and/or |
| Young′s Modulus (MPa) < | 352 |

In a fifth version of the first embodiment of the second aspect of the invention, the terpolymer may be that obtained by the reaction of ethylene, 4-methyl-1-pentene and 1-heptene.

In particular, the terpolymer of ethylene, 4-methyl-1-pentene and 1-heptene may have the following properties:

| Hardness = | 58 and/or |
|---|---|
| Impact Strength (kJ/m2) = | 16.9 and/or |
| Yield Strength (MPa) = | 21.3 and/or |
| Elongation at Yield (%) = | 50 and/or |
| Young′s Modulus (MPa) = | 622 |

In another particular case it may have the following properties:

| Hardness > | 58 and/or |
|---|---|
| Impact Strength (kJ/m2) > | 16.9 and/or |
| Yield Strength (MPa) > | 21.3 and/or |
| Elongation at Yield (%) > | 50 and/or |
| Young′s Modulus (MPa) > | 622 |

In still another particular case it may have the following properties:

| Hardness < | 58 and/or |
|---|---|
| Impact Strength (kJ/m2) < | 16.9 and/or |
| Yield Strength (MPa) < | 21.3 and/or |
| Elongation at Yield (%) < | 50 and/or |
| Young′s Modulus (MPa) < | 622 |

In a sixth version of the first embodiment of the second aspect of the invention, the terpolymer may be that obtained by the reaction of ethylene, 4-methyl-1-pentene and 1-octene.

In particular, the terpolymer of ethylene, 4-methyl-1-pentene and 1-octene may have the following properties:

| Hardness = | 33 and/or |
|---|---|
| Impact Strength (kJ/m2) = | 31.5 and/or |
| Yield Strength (MPa) = | 7.8 and/or |
| Elongation at Yield (%) = | 65 and/or |
| Young′s Modulus (MPa) = | 204 |

In another particular case it may have the following properties:

| Hardness > | 33 and/or |
|---|---|
| Impact Strength (kJ/m2) > | 31.5 and/or |
| Yield Strength (MPa) > | 7.8 and/or |
| Elongation at Yield (%) > | 65 and/or |
| Young′s Modulus (MPa) > | 204 |

In still another particular case it may have the following properties:

| Hardness < | 33 and/or |
|---|---|
| Impact Strength (kJ/m2) < | 31.5 and/or |
| Yield Strength (MPa) < | 7.8 and/or |
| Elongation at Yield (%) < | 65 and/or |
| Young′s Modulus (MPa) < | 204 |

In a seventh version of the first embodiment of the second aspect of the invention, the terpolymer may be that obtained by the reaction of ethylene, 4-methyl-1-pentene and 1-nonene.

In particular, the terpolymer of ethylene, 4-methyl-1-pentene and 1-nonene may have the following properties:

| Hardness = | 42 and/or |
|---|---|
| Impact Strength (kJ/m2) = | 38.5 and/or |
| Yield Strength (MPa) = | 14.9 and/or |
| Elongation at Yield (%) = | 90 and/or |
| Young′s Modulus (MPa) = | 274 |

In another particular case it may have the following properties:

| Hardness > | 42 and/or |
|---|---|
| Impact Strength (kJ/m2) > | 38.5 and/or |
| Yield Strength (MPa) > | 14.9 and/or |
| Elongation at Yield (%) > | 90 and/or |
| Young′s Modulus (MPa) > | 274 |

In still another particular case it may have the following properties:

| Hardness | < | 42 and/or |
|---|---|---|
| Impact Strength (kJ/m2) | < | 38.5 and/or |
| Yield Strength (MPa) | < | 14.9 and/or |
| Elongation at Yield (%) | < | 90 and/or |
| Young's Modulus (MPa) | < | 274 |

In an eighth version of the first embodiment of the second aspect of the invention, the terpolymer group may be that obtained by the reaction of ethylene, 4-methyl-1-pentene and 1-decene.

In particular, the terpolymer of ethylene, 4-methyl-1-pentene and 1-decene may have the following properties:

| Hardness | = | 5 and/or |
|---|---|---|
| Impact Strength (kJ/m2) | = | 11.5 and/or |
| Yield Strength (MPa) | = | 1.5 and/or |
| Elongation at Yield (%) | = | 34 and/or |
| Young's Modulus (MPa) | = | 103 |

In another particular case it may have the following properties:

| Hardness | > | 5 and/or |
|---|---|---|
| Impact Strength (kJ/m2) | > | 11.5 and/or |
| Yield Strength (MPa) | > | 1.5 and/or |
| Elongation at Yield (%) | > | 34 and/or |
| Young's Modulus (MPa) | > | 103 |

In still another particular case it may have the following properties:

| Hardness | < | 5 and/or |
|---|---|---|
| Impact Strength (kJ/m2) | < | 11.5 and/or |
| Yield Strength (MPa) | < | 1.5 and/or |
| Elongation at Yield (%) | < | 34 and/or |
| Young's Modulus (MPa) | < | 103 |

In a second embodiment of the second aspect of the invention, the polymer may be a terpolymer of ethylene, 3-methyl-1-butene as the branched alpha olefin, and the linear alpha olefin.

The linear alpha olefin can, as indicated hereinbefore, be any linear alpha olefin having a total number of carbon atoms between 3 and 10, leading thus to subgroups of terpolymers with differing third or linear alpha olefin content and differing application properties.

The terpolymer of ethylene with 3-methyl-1-butene as the second component and the linear alpha olefin as the third component may have the following properties:

a) a melt flow rate as measured according to ASTM D 1238 in -he range of 0,01 to about 100 g/10 min; and/or

b) a density as measured according to ASTM D 1505 in the range of about 0,335 to about 0,950; and/or

c) when its tensile strength at yield is plotted against its density, it conforms to the following equation:

σ>111,11ρ−95,56

where ρ is the density of the terpolymer as measured above and σ is its tensile strength at yield as measured according to ASTM D 638 M, with the domain for which the equation is valid being:

σ>0

and

0,86<ρ<0,96;

and/or

d) when its modulus is plotted against its density, it conforms to the following equation:

E>5555,56ρ−4833,3

where ρ is the density of the terpolymer as measured above and E is its modulus as measured according to ASTM D 638 M, with the domain for which the equation is valid being:

E>0

and

0,87<ρ<0,96.

In a first version of the second embodiment of the second aspect of the invention, the terpolymer may be that obtained by the reaction of ethylene with 3-methyl-1-butene and propylene.

In particular, the terpolymer of ethylene, 3-methyl-1-butene and propylene may have the following properties:

| Hardness | = | 40 and/or |
|---|---|---|
| Impact Strength (kJ/m2) | = | 30.1 and/or |
| Yield Strength (MPa) | = | 9.4 and/or |
| Elongation at Yield (%) | = | 37 and/or |
| Young's Modulus (MPa) | = | 476 |

In another particular case it may have the following properties:

| Hardness | > | 40 and/or |
|---|---|---|
| Impact Strength (kJ/m2) | > | 30.1 and/or |
| Yield Strength (MPa) | > | 9.4 and/or |
| Elongation at Yield (%) | > | 37 and/or |
| Young's Modulus (MPa) | > | 476 |

In still another particular case it may have the following properties:

| Hardness | < | 40 and/or |
|---|---|---|
| Impact Strength (kJ/m2) | < | 30.1 and/or |
| Yield Strength (MPa) | < | 9.4 and/or |
| Elongation at Yield (%) | < | 37 and/or |
| Young's Modulus (MPa) | < | 476 |

In a second version of the second embodiment of the second aspect of the invention, the terpolymer may be that obtained by the reaction of ethylene with 3-methyl-1-butene and 1-butene.

In particular, the terpolymer of ethylene, 3-methyl-1-butene and 1-butene may have the following properties:

| Hardness | = | 28 and/or |
|---|---|---|
| Impact Strength (kJ/m2) | = | 22.4 and/or |
| Yield Strength (MPa) | = | 5.6 and/or |
| Elongation at Yield (%) | = | 144 and/or |
| Young's Modulus (MPa) | = | 199 |

In another particular case it may have the following properties:

| Hardness | > | 28 and/or |
|---|---|---|
| Impact Strength (kJ/m2) | > | 22.4 and/or |
| Yield Strength (MPa) | > | 5.6 and/or |
| Elongation at Yield (%) | > | 144 and/or |
| Young's Modulus (MPa) | > | 199 |

In still another particular case it may have the following properties:

| Hardness | < | 28 and/or |
|---|---|---|
| Impact Strength (kJ/m2) | < | 22.1 and/or |
| Yield Strength (MPa) | < | 5.6 and/or |
| Elongation at Yield (%) | < | 144 and/or |
| Young's Modulus (MPa) | < | 199 |

In a third version of the second embodiment of the second aspect of the invention, the terpolymer may be that obtained by the reaction of ethylene, 3-methyl-1-butene and 1-pentene.

In particular, the terpolymer of ethylene, 3-methyl-1-butene and 1-pentene may have the following properties:

| Hardness = | 53 and/or |
|---|---|
| Impact Strength (kJ/m2) = | 47.7 and/or |
| Yield Strength (MPa) = | 15.2 and/or |
| Elongation at Yield (%) = | 83 and/or |
| Young's Modulus (MPa) = | 477 |

In another particular case it may have the following properties:

| Hardness > | 53 and/or |
|---|---|
| Impact Strength (kJ/m2) > | 47.7 and/or |
| Yield Strength (MPa) > | 15.2 and/ar |
| Elongation at Yield (%) > | 83 and/or |
| Young's Modulus (MPa) > | 477 |

In still another particular case it may have the following properties:

| | |
|---|---|
| Hardness < | 53 and/or |
| Impact Strength (kJ/m2) < | 47.7 and/or |
| Yield Strength (MPa) < | 15.2 and/or |
| Elongation at Yield (%) < | 83 and/or |
| Young's Modulus (MPa) < | 477 and/or |

In a fourth version of the second embodiment of the second aspect of the invention, the terpolymer may be that obtained by the reaction of ethylene, 3-methyl-1-butene and 1-hexene.

In particular, the terpolymer of ethylene, 3-methyl-1-butene and 1-hexene may have the following properties:

| Hardness = | 14 and/or |
|---|---|
| Impact Strength (kJ/m2) = | 10 and/or |
| Yield Strength (MPa) = | 1.7 and/or |
| Elongation at Yield (%) = | 74 and/or |
| Young's Modulus (MPa) = | 52 |

In another particular case it may have the following properties:

| Hardness > | 14 and/or |
|---|---|
| Impact Strength (kJ/m2) > | 10 and/or |
| Yield Strength (MPa) > | 1.7 and/or |
| Elongation at Yield (%) > | 74 and/or |
| Young's Modulus (MPa) > | 52 |

In still another particular case it may have the following properties:

| Hardness < | 14 and/or |
|---|---|
| Impact Strength (kJ/m2) < | 10 and/or |
| Yield Strength (MPa) < | 1.7 and/or |
| Elongation at Yield (%) < | 74 and/or |
| Young's Modulus (MPa) < | 52 |

In a fifth version of the second embodiment of the second aspect of the invention, the terpolymer may be that obtained by the reaction of ethylene, 3-methyl-1-butene and 1-heptene.

In particular, the terpolymer of ethylene, 3-methyl-1-butene and 1-heptene may have the following properties:

| Hardness = | 51 and/or |
|---|---|
| Impact Strength (kJ/m2) = | 28.3 and/or |
| Yield Strength (MPa) = | 12.9 and/or |
| Elongation at Yield (%) = | 48 and/or |
| Young's Modulus (MPa) = | 406 |

In another particular case it may have the following properties:

| Hardness > | 51 and/or |
|---|---|
| Impact Strength (kJ/m2) > | 28.3 and/or |
| Yield Strength (MPa) > | 12.9 and/or |
| Elongation at Yield (%) > | 48 and/or |
| Young's Modulus (MPa) > | 406 |

In still another particular case it may have the following properties:

| Hardness < | 51 and/or |
|---|---|
| Impact Strength (kJ/m2) < | 29.3 and/or |
| Yield Strength (MPa) < | 12.9 and/or |
| Elongation at Yield (%) < | 48 and/or |
| Young's Modulus (MPa) < | 406 |

In a sixth version of the second embodiment of the second aspect of the invention, the terpolymer may be that obtained by the reaction of ethylene, 3-methyl-1-butene and 1-octene.

In particular, the terpolymer of ethylene, 3-methyl-1-butene and 1-octene may have the following properties:

| Hardness = | 49 and/or |
|---|---|
| Impact Strength (kJ/m2) = | 39.8 and/or |
| Yield Strength (MPa) = | 9.9 and/or |
| Elongation at Yield (%) = | 53 and/or |
| Young's Modulus (MPa) = | 380 |

In another particular case it may have the following properties:

| Hardness | > | 49 and/or |
|---|---|---|
| Impact Strength (kJ/m2) | > | 39.8 and/or |
| Yield Strength (MPa) | > | 9.9 and/or |
| Elongation at Yield (%) | > | 53 and/or |
| Young's Modulus (MPa) | > | 380 |

In still another particular case it may have the following properties:

| Hardness | < | 49 and/or |
|---|---|---|
| Impact Strength (kJ/m2) | < | 39.8 and/or |
| Yield Strength (MPa) | < | 9.9 and/or |
| Elongation at Yield (%) | < | 53 and/or |
| Young's Modulus (MPa) | < | 380 |

In a seventh version of the second embodiment of the second aspect of the invention, the terpolymer may be that obtained by the reaction of ethylene, 3-methyl-1-butene and 1-nonene.

In particular, the terpolymer of ethylene, 3-methyl-1-butene and 1-nonene may have the following properties:

| Hardness | = | 43 and/or |
|---|---|---|
| Impact Strength (kJ/m2) | = | 24.2 and/or |
| Yield Strength (MPa) | = | 10.2 and/or |
| Elongation at Yield (%) | = | 41 and/or |
| Young's Modulus (MPa) | = | 403 |

In another particular case it may have the following properties:

| Hardness | > | 43 and/or |
|---|---|---|
| Impact Strength (kJ/m2) | > | 24.2 and/or |
| Yield Strength (MPa) | > | 10.2 and/or |
| Elongation at Yield (%) | > | 41 and/or |
| Young's Modulus (MPa) | > | 403 |

In still another particular case it may have the following properties:

| Hardness | < | 43 and/or |
|---|---|---|
| Impact Strength (kJ/m2) | < | 24.2 and/or |
| Yield Strength (MPa) | < | 10.2 and/or |
| Elongation at Yield (%) | < | 41 and/or |
| Young's Modulus (MPa) | < | 403 |

In an eighth version of the second embodiment of the second aspect of the invention, the terpolymer group may be that obtained by the reaction of ethylene, 3-methyl-1-butene and 1-decene.

In particular, the terpolymer of ethylene, 3-methyl-1-butene and 1-decene may have the following properties:

| Hardness | = | 46 and/or |
|---|---|---|
| Impact Strength (kJ/m2) | = | 30.6 and/or |
| Yield Strength (MPa) | = | 13.3 and/or |
| Elongation at Yield (%) | = | 52 and/or |
| Young's Modulus (MPa) | = | 347 |

In another particular case it may have the following properties:

| Hardness | > | 46 and/or |
|---|---|---|
| Impact Strength (kJ/m2) | > | 30.6 and/or |
| Yield Strength (MPa) | > | 12.3 and/or |
| Elongation at Yield (%) | > | 52 and/or |
| Young's Modulus (MPa) | > | 347 |

In still another particular case it may have the following properties:

| Hardness | < | 46 and/or |
|---|---|---|
| Impact Strength (kJ/m2) | < | 30.6 and/or |
| Yield Strength (MPa) | < | 13.3 and/or |
| Elongation at Yield (%) | < | 52 and/or |
| Young's Modulus (MPa) | < | 347 |

In a third embodiment of the first aspect of the invention, the polymer may be a terpolymer of ethylene, 4-methyl-1-hexene as the branched alpha olefin, and the linear alpha olefin.

The linear alpha olefin can, as also indicated hereinbefore, be any linear alpha olefin having a total number of carbon atoms between 3 and 10, leading thus to subgroups of terpolymers with differing third or linear alpha olefin content and differing application properties.

According to a third aspect of the invention, there is provided a polymer of ethylene as a first component or monomer, with at least one branched alpha olefin as a second component or monomer and at least one different branched alpha olefin as a third component or monomer.

In other words, according to the third aspect of the invention, there is provided a polymer which is the reaction product of ethylene as a first component or monomer with at least one branched alpha olefin as a second component or monomer and at least one different branched alpha olefin as a third component or monomer.

Further, according to the third aspect of the invention, there is provided a terpolymer of ethylene as a first component or monomer with a branched alpha olefin as a second component or monomer and a different branched alpha olefin as a third component or monomer.

Still further, according to the third aspect of the invention, there is provided a polymer of ethylene with at least two different branched alpha olefins.

By replacing the linear alpha olefin as the third component of the family of terpolymers according to the second aspect of invention, by a different branched olefin according to the third aspect of the invention, a new family of terpolymers is obtained, with these terpolymers having even more surprising behaviour and which thus increases the range of applications thereof.

The inventors have surprisingly found that in the family of the terpolymers of ethylene with two different branched alpha olefins according to this aspect of the invention, there are particular sub-families of polymers where even more surprising application properties can be found. A terpolymer of ethylene obtained by the terpolymerization of ethylene with the second component branched alpha olefin and with the third component branched alpha olefin having a total number of carbon atoms equal to six, differs unexpectedly from a terpolymer of ethylene obtained by the terpolymerization of ethylene with the second component branched alpha olefin component and with the third component branched alpha olefin having a total number of carbon atoms in excess of six, and from a terpolymer of ethylene obtained by the terpolymerization of ethylene with the second component branched alpha olefin and with the third component branched alpha olefin having a total number of carbon atoms fewer than six.

The properties of the terpolymers in each family are determined mainly by the ratio of the proportion of ethylene to the sum of the properties of the branched alpha olefins, and by the ratio of the proportions of the two different branched alpha olefins. In other words, the properties of the terpolymer, based on the ethylene sum of the total comonomer content, on a molar basis, differ by varying the molar ratio of the two-branched alpha olefins. In this way, a large range of particular terpolymers can be obtained with a large range of application properties controlled between certain limits. Typical applications of the terpolymer include extrusions, blow moulding and injection moulding.

The ratio of the molar proportion of the ethylene to the sum of the molar proportions of the first branched alpha olefin and the second branched alpha olefin may be from 99,9:0,1 to 80:20. The preferred ratio of the molar proportion of the ethylene to the sum of the molar proportions of the first branched alpha olefin and the second branched alpha olefin is from 99,9:0,1 to 90:10. The most preferred ratio of the molar proportion of the ethylene to the sum of the molar proportions of the first branched alpha olefin and the second branched alpha olefin may be from 99,9:0,1 to 95:5.

The ratio of the molar proportion of the first branched alpha olefin to that of the second branched alpha olefin may be from 0,1:99,9 to 99,9:0,1. The preferred ratio of the molar proportion of the first branched alpha olefin to that of the second branched alpha olefin may be from 1:99 to 99:1. The most preferred ratio of the molar proportion of first branched alpha olefin to that of the second branched alpha olefin may be from 2:98 to 98:2.

In particular, the polymer according to the third aspect of the invention, may be that obtained by reacting ethylene, a first branched alpha olefin and a further or second branched alpha olefin in one or more reaction zones, while maintaining in the reaction zone(s) a pressure in the range between atmospheric pressure and 5000 kg/cm² and a temperature between ambient and 300° C., in the presence of a suitable catalyst or catalyst system.

In a first embodiment of the third aspect of the invention, the polymer may be a terpolymer of ethylene, 4-methyl-1-pentene and a third differnt branched alpha olefin.

It was hitherto generally believed that polymers of ethylene and 3-methyl-1-pentene had no practical applications. The inventors have, however, surprisingly found that when ethylene is terpolymerized according to this invention with 4-methyl-1-pentene and 3-methyl-1-pentene, the reaction is not only feasible but polymers having excellent application properties can be obtained.

In a first version of the first embodiment of the third aspect of the invention, the polymer may be a terpolymer of ethylene, 4-methyl-1-pentene and 3-methyl-1-pentene.

The terpolymer of ethylene with 4-methyl-1-pentene as the second component and a 3-methyl-1-pentene as the third component may have the following properties:

a) a melt flow rate as measured according to ASTM D 1238 in the range of 0,01 to about 100 g/10 min; and/or

b) a density as measured according to ASTM D 1505 in the range of about 0,890 to about 0,950; and/or

c) when its tensile strength at yield terpolymers is plotted against its density, it conforms to the following equation:

σ>240ρ−212,4

where ρ is the density of the terpolymer as measured above and σ is its tensile strength at yield as measured according to ASTM D 638 M, with the domain for which the equation is valid being:

σ>0

and

0,885<ρ<0,96;

and/or

d) when its modulus is plotted against its density, it conforms to the following equation:

E>700/0,06ρ−10500

where ρ is the density of the terpolymer as measured above and E is its modulus as measured according to ASTM D 638 M, with the domain for which the equation is valid being:

E>0

and

0,9<ρ<0,96;

and/or

e) when its impact strength is plotted against its density, it conforms to the following equation:

I>150ρ−109

where ρ is the density of the terpolymer as measured above and I is its impact strength as measured according to ASTM D 256 M, with the domain for which the equation is valid being:

I>20

and

0,86<ρ<0,943.

In particular, the terpolymer of ethylene, 3-methyl-1-pentene and 4-methyl-1-pentene may have the following properties:

| Hardness | = | 32 and/or |
|---|---|---|
| Impact Strength (kJ/m2) | = | 27 and/or |
| Yield Strength (MPa) | = | 4.8 and/or |
| Elongation at Yield (%) | = | 55 and/or |
| Young's Modulus (MPa) | = | 272 |

In another particular case it may have the following properties:

| Hardness | > | 32 and/or |
|---|---|---|
| Impact Strength (kJ/m2) | > | 27 and/or |
| Yield Strength (MPa) | > | 4.8 and/or |
| Elongation at Yield (%) | > | 55 and/or |
| Young's Modulus (MPa) | > | 272 |

In still another particular case it may have the following properties:

| Hardness | < | 32 and/or |
|---|---|---|
| Impact Strength (kJ/m2) | < | 27 and/or |
| Yield Strength (MPa) | < | 4.8 and/or |
| Elongation at Yield (%) | < | 55 and/or |
| Young's Modulus (MPa) | < | 272 |

In a second version of the first embodiment of the third aspect of the invention, the polymer may be a terpolymer of ethylene, 3-methyl-1-butene and 4-methyl-1-pentene.

In particular, the terpolymer of ethylene, 3-methyl-1-butene and 4-methyl-1-pentene may have the following properties:

| Hardness | = | 56 and/or |
|---|---|---|
| Impact Strength (kJ/m2) | = | 51.2 and/or |
| Yield Strength (MPa) | = | 16.1 and/or |
| Young's Modulus (MPa) | = | 451 |

In another particular case it may have the following properties:

| Hardness | > | 56 and/or |
|---|---|---|
| Impact Strength (kJ/m2) | > | 51.2 and/or |
| Yield Strength (MPa) | > | 16.1 and/or |
| Young's Modulus (MPa) | > | 451 |

In still another particular case it may have the following properties:

| Hardness | < | 56 and/or |
|---|---|---|
| Impact Strength (kJ/m2) | < | 51.2 and/or |
| Yield Strength (MPa) | < | 16.1 and/or |
| Young's Modulus (MPa) | < | 451 |

In a second embodiment of the third aspect of the invention, the polymer may be a terpolymer of ethylene, 4-methyl-1-hexene and a third different branched alpha olefin.

The Applicant has also found that in the polymerization of ethylene with a linear alpha olefin and a further branched alpha olefin or in the polymerization of ethylene with two branched alpha olefins, even more particular polymers are obtained when different particular processes are employed for the polymerization.

Thus, according to a fourth aspect of the invention, there is provided a process for producing a polymer, which process comprises reacting at least ethylene as a first component or monomer, with a branched alpha olefin as a second component or monomer, and with a linear alpha olefin as a third component or monomer, in one or more reaction zones, while maintaining the reaction zone(s) at a pressure between atmospheric pressure and 5000 kg/cm², and at a temperature between ambient and 300° C., in the presence of a particular catalyst or a catalyst system comprising a particular catalyst and a cocatalyst.

The reaction is thus carried out in one or more reaction zones, which may be provided in a single stage reactor vessel or by a chain of two or more reaction vessels.

The reaction can be effected in a batch fashion, with the further branched alpha olefin and the linear alpha olefin being added simultaneously at the start of the reaction while the ethylene is added continuously during the course of the reaction, and with no product being removed during the reaction. Instead, the reaction can be effected in a batch fashion, with the linear alpha olefin and the further branched alpha olefin being added simultaneously with the ethylene and continuously or discontinuously during the course of the reaction, and with no product being removed during the reaction. Still further, the reaction can be effected in a batch fashion, with either the linear alpha olefin or the further branched alpha olefin being added at the start of the reaction while ethylene is added continuously during the reaction, with a continuous or discontinuous supply of the monomer which was not added at the beginning of the reaction being provided, and with no product being removed during the reaction.

The reaction can, however, also be effected in a continuous fashion, with the ethylene being added continuously and the linear alpha olefin and the further branched alpha olefin being added together or separately, continuously or discontinuously, during the course of the reaction, and the terpolymer product continuously being withdrawn from the reaction zone.

Polymers obtained from the process, and based on particular feed compositions and particular reaction conditions, have a distribution which is determined mainly by the different reactivities of the monomers. This provides a unique tool for obtaining a large variety of ethylene, further branched alpha olefin and linear alpha clef in polymers whose properties are mainly controlled by their composition and non-uniformity.

The molecular weigh of the resultant polymer can be regulated by hydrogen addition to the reaction zone during the reaction. The greater the amount of hydrogen added, the lower will be the molecular weight of the polymer.

The polymerization is preferably performed in a substantially oxygen and water free state, and in the presence or absence of an inert saturated hydrocarbon.

The polymerization reaction according to this aspect of the invention may be carried out in slurry phase, solution phase or vapour phase, with slurry phase polymerization being preferred.

Any suitable catalyst or catalyst system which co-polymerises ethylene with olefins can, at least in principle, be used. Catalysts such as heterogeneous Ziegler-Natta, chromium based, metallocene, single site and other types of catalyst are known in the literature. A catalyst system comprising a titanium catalyst supported or loaded on activated magnesium chloride is, however, preferred.

The most preferred catalyst is a particularly prepared titanium catalyst particularly loaded on a particularly activated magnesium chloride.

Thus, according to one embodiment of this aspect of the invention, there is provided a process for producing a polymer, which process comprises reacting at least ethylene as a first component or monomer, a branched alpha olefin as a second component or monomer, and a linear alpha olefin as a third component or monomer in one or more reaction zones, while maintaining the reaction zone(s) at a pressure between atmospheric pressure and 5000 kg/cm², and at a temperature between ambient and 300° C., in the presence of a particular catalyst, or a catalyst system comprising a particular catalyst and a cocatalyst, with the particular catalyst being that obtained by:

i) suspending partially anhydrous magnesium chloride in a highly purified hydrocarbon solvent to obtain a magnesium chloride slurry;

ii) adding to the slurry at least one alcohol and one ether and stirring the mixture for a period of time to obtain a partially activated magnesium chloride;

iii) adding thereto, in drop wise fashion, an alkyl aluminium compound, with the resultant mixture being ground to a smooth consistency, and thereafter cooled to room temperature, to obtain an activated magnesium chloride;

iv) washing the activated magnesium chloride with a highly purified hydrocarbon solvent, to obtain a washed activated magnesium chloride, which constitutes the support of the catalyst;

v) adding a mixture of alcohols to the washed support, followed by stirring, to obtain an alcohol loaded support;

vi) adding titanium tetrachloride to the alcohol loaded support and stirring the resultant mixture under reflux for a period of time to obtain a titanium loaded catalyst; and

vii) cooling and then washing the titanium loaded catalyst with a highly purified hydrocarbon solvent, followed by drying and pulverising thereof to obtain the catalyst.

Preferred hydrocarbon solvents are inert saturated hydrocarbon liquids, such as aliphatic or cycloaliphatic liquid hydrocarbons. The most preferred are hexane and heptane.

The ether(s) may be selected from linear ethers having a total number of carbon atoms between 8 and 16. The alcohol(s) may be selected from the alcohol range having 2 to 8 carbon atoms. The mixtures may be stirred for between 1 and 12 hours, and at a temperature between 40° C. and 140° C.

The alkyl aluminium compounds have the formula AlRm wherein Rm is a radical component having 1 to 10 carbon atoms.

According to another embodiment of this aspect of the invention, there is provided a process for producing a polymer, which process comprises reacting at least ethylene as a first component or monomer, with a branched alpha olefin as a second component or monomer, and with a linear alpha olefin as a third component or monomer, in one or more reaction zones, while maintaining the reaction zone(s) at a pressure between atmospheric pressure and 5000 kg/cm², and at a temperature between ambient and 300° C., in the presence of a particular catalyst, or a catalyst system comprising a particular catalyst and a cocatalyst, with the particular catalyst being that obtained by:

i) suspending partially anhydrous magnesium chloride in a highly purified hydrocarbon solvent to obtain a magnesium chloride slurry;

ii) adding to the slurry at least one ether and stirring the mixture for a period of time to obtain a partially activated magnesium chloride;

iii) filtering and washing the partially activated magnesium chloride slurry with a highly purified hydrocarbon solvent until no ether is detected in the washing liquid, to obtain a washed partially activated magnesium chloride;

iv) adding thereto, in drop wise fashion, an alkyl aluminium compound followed by grinding to a smooth consistency and cooling to room temperature, to obtain an activated magnesium chloride;

v) washing the activated magnesium chloride with a highly purified hydrocarbon solvent until no alkyl aluminium is detected in the washing liquid, to obtain a washed activated magnesium chloride, which constitutes the support of the catalyst;

vi) adding a mixture of alcohols to the washed support, followed by stirring, to obtain an alcohol loaded support;

vii) washing the alcohol loaded support with a highly purified hydrocarbon solvent, to obtain a washed alcohol loaded support;

viii) adding titanium tetrachloride to the washed alcohol loaded support, and grinding it to a smooth consistency to obtain a titanium loaded catalyst; and

ix) washing the titanium loaded catalyst with a highly purified hydrocarbon solvent until no titanium is detected in the washing liquid, to obtain the catalyst.

As hereinbefore set out, the magnesium chloride may be partially anhydrised and may have a water content between 0,02 mole of water/mole of magnesium chloride and 2 mole of water/mole of magnesium chloride.

Preferred hydrocarbon solvents are inert saturated hydrocarbon liquids, such as aliphatic or cycloaliphatic liquid hydrocarbons. The most preferred are hexane and heptane.

The ethers may be selected from linear ethers having a total number of carbon atoms between 8 and 16. The mixtures may be stirred for between 1 and 12 hours, and at a temperature between 40° C. and 140° C.

The alkyl aluminium compound may have the formula AlRm wherein Rm is a radical component having 1 to 10 carbon atoms. The alkyl aluminium compound used in this embodiment of this aspect of the invention is free of chlorine.

The catalyst may-be prepolymerized.

For the prepolymerization, alpha olefins of 2 to 8 carbon atoms are preferred. The amount of polymer resulting from the prepolymerization is preferably in the range of 1 to 500 polymer/g of catalyst.

Thus, according to another embodiment of this aspect of the invention, there is provided a process for producing a polymer, which process comprises reacting at least ethylene as a first component or monomer, with a branched alpha olefin as a second component or monomer and with a linear alpha olefin as a third component or monomer, in one or more reaction zones, while maintaining the reaction zone(s) at a pressure between atmospheric pressure and 5000 kg/cm², and at a temperature between ambient and 300° C., in the presence of a particular catalyst, or a catalyst system comprising a particular catalyst and a cocatalyst, wherein the catalyst has been prepolymerized with an alpha olefin having 2 to 8 carbon atoms or with a mixture of alpha olefins having 2 to 8 carbon atoms, and wherein the amount of polymer which results from the prepolymerization is in the range of 1 to 500 polymer/g of catalyst.

Preferably, the prepolymerization is performed with the same monomers as are reacted in the process.

Different methods of prepolymerization may be used. However the most preferred method has the following steps:

i) adding, in a closed vessel under inert conditions, an amount of 1 to 10 weight % of the trialkyl aluminium compound under stirring to a highly purified hydrocarbon solvent at about 80° C., to obtain a liquid mixture;

ii) adding an amount of 0,1-1 weight % of the catalyst to the liquid mixture;

iii) adding an amount of less than 0,5 weight % of hydrogen to the closed vessel;

iv) continuously supplying the monomers separately or as a mixture, until a desired increase of weight is achieved corresponding to a desired polymer/catalyst ratio; and

v) filtering the resultant prepolymerized catalyst and washing it with a hydrocarbon solvent, followed by another filtration step and subsequent drying thereof.

For a gas phase process, the catalyst is usually prepolymerized or supported. The most preferred prepolymerization is performed with the same monomers as are reacted in the process. The most preferred support is the terpolymer powder with the same composition as the terpolymer to be obtained in the terpolymerization, and this support is treated with the same alkyl aluminium used as cocatalyst in the terpolymerization.

When the catalyst prepared according to this invention is used for the terpolymerization, a cocatalyst may be used. The preferred cocatalysts have the formula AlRm wherein Rm is a radical component having 1 to 10 carbon atoms.

For a solution polymerization, the temperature of the process and the solvent will be selected such that the terpolymer is wholly soluble in the selected solvent during the terpolymerization.

The olefinic monomers employed in the terpolymerization according to this aspect of invention may be obtained from a Fischer-Tropsch process as hereinbefore described; however, any other polymerization grade olefinic monomers obtained from other processes may be employed instead of one or more olefinic monomers obtained from the Fischer-Tropsch process, as hereinbefore described.

Thus, in one embodiment of this aspect of the invention, the ethylene may be that obtained from a Fischer-Tropsch process. However as hereinbefore presented, due to the process of working up, ie separation and purification, involved in Fischer-Tropsch ethylene production, polymers containing Fischer-Tropsch derived ethylene may, in some cases, not show any difference to polymers containing the ethylene obtained for conventional processes.

In another embodiment of this aspect of the invention, the branched alpha olefin may be Fischer-Tropsch derived. Nearly all known alpha olefins, which have practical application, can be obtained from a Fischer-Tropsch process. However the preferred branched alpha olefins are those that have a carbon number between 4 an 10. The most preferred ones are those which have the branch situated at the far end relative to the double bond. These olefins may contain small amounts of other olefins.

Examples of such most preferred branched olefins are 3-methyl-1-butene, 4-methyl-1-pentene, 4-methyl-1-hexene and 3-methyl-1-pentene. A mixture of 4-methyl-1-pentene and 3-methyl-1-pentene is also preferred.

In another embodiment of this aspect of the invention, the linear alpha olefin may be that obtained from the Fischer-Tropsch process. Typical examples of such linear alpha olefins are propylene, 1-butene, 1-pentene, 1-hexene, 1-heptene, 1-octene, 1-nonene and 1-decene. Preferred examples of such olefins have a carbon number between 3 and 9, and the most preferred have a carbon number between 4 and 8. These olefins may contain small amounts of other olefinic components, as hereinbefore described.

Typical examples of Fischer-Tropsch derived olefins which can be used in the different aspects of the invention as the second and/or third components are those as hereinbefore described in respect of this aspect of the invention, and which typically have levels of other olefinic components present therein as hereinbefore described. Thus, in one embodiment of this aspect of the invention, the second component and/or the third component may comprise from 0,002% to 2%, by mass, other olefinic components. In another embodiment of this aspect of the invention, the second component and/or the third component may comprise from 0,02% to 2%, by mass, other olefinic components. In yet another embodiment of this aspect of the invention, the second component and/or the third component may comprise from 0,2% to 2%, by mass, other olefinic components. In a still further embodiment of this aspect of the invention, the second component or the third component may comprise from 0,2% to in excess of 2%, by mass, other olefinic components, provided that when the other olefinic components are present in the one component in an amount in excess of 2%, by mass, they will be present in the other component in an amount proportionally less than 2%. Naturally, a lesser amount of the other olefinic components can then be present in the other component, if desired.

Typical examples of the other olefinic components include

1-pentene, with the total of the other olefinic components being 0,5% and comprising mainly:

1-2-methyl-1-butene -0,46%

very low proportion of branched olefins having a carbon number of 5

very low proportion of internal olefins having a carbon number of 5

very low proportion of cyclic olefins having a carbon number of 5

very low proportion of dienes

1-hexene, with the other olefinic components comprising mainly:

branched olefins, mainly having a carbon number of 6-0,51%

internal olefins, mainly having a carbon number of 6-0,18%

cyclic olefins, mainly having a carbon number of 6-0,13%

very low proportion of dienes

1-heptene, with the other olefinic components comprising mainly:

branched olefins, mainly having a carbon number of 7-0,48%

internal olefins, mainly having a carbon number of 7-0,53%

1-octene, with the other olefinic components comprising mainly:

branched olefins, mainly having a carbon number of 8-0,41%

internal olefins, mainly having a carbon number of 8-0,83%

1-nonene, with the other olefinic components comprising mainly:

branched olefins, mainly having a carbon number of 9-0,65%

internal olefins, mainly having a carbon number of 9-0,51%

3-methyl-1-butene, with the other olefinic components comprising mainly internal olefins having 4 carbon atoms—0,03%, and a very low amount of dienes

1:1 Mixture of 4-methyl-1-pentene and 3-methyl-1-pentene wherein the total of the other olefinic components (2%) comprises mainly 2,3-di-methyl-1-butene

4-methyl-1-pentene wherein the total of the other olefinic components is 2%, and comprise mainly 3-methyl-1-pentene

These typical examples do not, however, exclude other olefinic components from being present, provided that the monomers comply with the limits as hereinbefore set out, as regards the total content of other olefinic components present therein.

As indicated hereinbefore, when the third monomer or component comprises propylene or 1-butene, and has been obtained from the Fischer-Tropsch process, it may first have been worked up such that it is substantially identical to other commercially available propylene or 1-butene, in which case polymers according to the invention and which are derived from such propylene or 1-butene may not show any difference to polymers according to the invention and which have been derived from other commercially available propylene or 1-butene.

In one embodiment of this aspect of the invention, ethylene may be copolymerized with 4-methyl-1-pentene as the branched alpha olefin and a linear alpha olefin.

The linear alpha olefin can be any linear alpha olefin having a total number of carbon atoms between 3 and 10, leading thus to subgroups of particular process versions that differ as regards the third component, ie the linear alpha olefin employed.

In a first version of this embodiment of this aspect of the invention, the third monomer is propylene.

In a second version of this embodiment of this aspect of the invention, the third monomer is 1-butene.

In a third version of this embodiment of this aspect of the invention, the third monomer is 1-pentene.

In a fourth version of this embodiment of this aspect of the invention, the third monomer is 1-hexene.

In a fifth version of this embodiment of this aspect of the invention, the third monomer is 1-heptene.

In a sixth version of this embodiment of this aspect of the invention, the third monomer is 1-octene.

In a seventh version of this embodiment of this aspect of the invention, the third comonomer is 1-nonene.

In an eighth version of this embodiment of this aspect of the invention, the third comonomer is 1-decene.

In another embodiment of this aspect of the invention, ethylene may be copolymerized with 3-methyl-1-butene as the branched alpha olefin and a linear alpha olefin.

The linear alpha olefin can be any linear alpha olefin having a total number of carbon atoms between 3 and 10, leading thus to subgroups of particular process versions that differ as regards the third component, ie the linear alpha olefin employed.

In a first version of this embodiment of this aspect of the invention, the third monomer is propylene.

In a second version of this embodiment of this aspect of the invention, the third monomer is 1-butene.

In a third version of this embodiment of this aspect of the invention, the third monomer is 1-pentene.

In a fourth version of this embodiment of this aspect of the invention, the third monomer is 1-hexene.

In a fifth version of this embodiment of this aspect of the invention, the third monomer is 1-heptene.

In a sixth version of this embodiment of this aspect of the invention, the third monomer is 1-octene.

In a seventh version of this embodiment of this aspect of the invention, the third comonomer is 1-nonene.

In an eighth version of this embodiment of this aspect of the invention, the third comonomer is 1-decene.

According to a fifth aspect of the invention, there is provided a process for producing a terpolymer, which process comprises reacting ethylene, a first branched alpha olefin and a second different branched alpha olefin in one or more reaction zones, while maintaining the reaction zone(s) at a pressure between atmospheric pressure and 5000 kg/cm²₁ and at a temperature between ambient and 300° C., in the presence of a particular catalyst, or a catalyst system comprising a particular catalyst and a cocatalyst.

The reaction is thus carried out also in one or more reaction zones, which may be provided in a single stage reactor vessel or by a chain of two or more reaction vessels.

Thus, as also indicated hereinbefore in respect of the fourth aspect of the invention, the reaction can be effected in a batch fashion, with the first branched alpha olefin and the second branched alpha olefin being added simultaneously at the start of the reaction, while the ethylene is added continuously during the course of the reaction, and with no product being removed during the reaction. Instead, the reaction can be effected in a batch fashion, with the first branched alpha olefin and the second branched alpha olefin being added simultaneously with ethylene and continuously or discontinuously during the course of the reaction, and with no product being removed during the reaction. Still further, the reaction can be effected in a batch fashion, with either the first branched alpha olefin or the second branched alpha olefin being added at the start of the reaction while ethylene is added continuously during the reaction and a continuous or discontinuous supply of the monomer which was not added at the beginning of the reaction being provided, and with no product being removed during the reaction.

The reaction can, however, also be effected in a continuous fashion, with the ethylene being added continuously and the first branched alpha olefin and the second branched alpha olefin being added together or separately, continuously or discontinuously, during the course of the reaction, and the terpolymer product continuously being withdrawn from the reaction zone.

Terpolymers obtained from the process according to this aspect of the invention, and based on particular feed compositions and particular reaction conditions, have a distribution which is determined mainly by the different reactivities of the monomers, with the reaction rates of branched alpha olefins generally being lower than those of their corresponding linear alpha olefins. This provides a more particular tool for obtaining a large variety of ethylene, first branched alpha olefin and second branched alpha olefin terpolymers whose properties are mainly controlled by their composition and non-uniformity.

The molecular weight of the resultant random terpolymer can be regulated by hydrogen addition to the reaction zone during the reaction. The greater the amount of hydrogen added, the lower will be the molecular weight of the random terpolymer.

The terpolymerization is preferably performed in a substantially oxygen and water free state, and in the presence or absence of an inert saturated hydrocarbon.

The terpolymerization reaction according to this aspect of the invention may also be carried out in slurry phase, solution phase or vapour phase, with slurry phase polymerization being preferred.

Any suitable catalyst or catalyst system which co-polymerises ethylene with olefins can, at least in principle be used. Catalysts such as heterogeneous Ziegler-Natta, chromium based, metallocene, single site and other types of catalyst are known in the literature. A catalyst system comprising a titanium catalyst supported or loaded on activated magnesium chloride is, however, preferred.

The most preferred catalysts are the two particularly prepared titanium catalysts particularly loaded on a particularly activated magnesium chloride prepared according to the fourth aspect of the invention, as hereinbefore described. However an additional method of catalyst preparation is also preferred.

Thus, according to one embodiment of this aspect of the invention, there is provided a process for producing a polymer, which process comprises reacting at least ethylene as a first component or monomer, with a branched alpha olefin as a second component or monomer and with a different branched alpha olefin as a third component or monomer in one or more reaction zones, while maintaining the reaction zone(s) at a pressure between atmospheric pressure and 5000 kg/cm², and at a temperature between ambient and 300° C., in the presence of a particular catalyst, or a catalyst system comprising a particular catalyst and a cocatalyst, with the particular catalyst being that obtained by:

i) suspending partially anhydrous magnesium chloride in a highly purified hydrocarbon solvent to obtain a magnesium chloride slurry;

ii) adding to the slurry at least one ether and stirring the mixture for a period of time to obtain a partially activated magnesium chloride;

iii) washing the partially activated magnesium chloride with a highly purified hydrocarbon solvent until no ether is detected in the washing liquid, to obtain a washed partially activated magnesium chloride;

iv) adding thereto, in drop wise fashion, an alkyl aluminium compound under stirring, and cooling to room temperature, to obtain an activated magnesium chloride;

v) washing the activated magnesium chloride with a highly purified hydrocarbon solvent until no alkyl aluminium is detected in the washing liquid, to obtain a washed activated magnesium chloride, which constitutes the support of the catalyst;

vi) adding a mixture of alcohols to the washed support, followed by stirring, to obtain an alcohol loaded support;

vii) washing the alcohol loaded support with a highly purified hydrocarbon solvent, to obtain a washed alcohol loaded support;

viii) adding titanium tetrachloride to the washed alcohol loaded support, and grinding it to a smooth consistency to obtain a titanium loaded catalyst; and

ix) thoroughly washing the titanium loaded catalyst with a highly purified hydrocarbon solvent until no titanium is detected in the washing liquid, to obtain the catalyst.

The magnesium chloride may be partially anhydrised and may have a water content between 0,02 mole of water/1-mole of magnesium chloride and 2 mole of water/1 mole of magnesium chloride.

Preferred hydrocarbon solvents are inert saturated hydrocarbon liquids, like aliphatic or cycloaliphatic liquid hydrocarbon. The most preferred are hexane and heptane.

The ether(s) may be selected from linear ethers having a total number of carbon atoms between 8 and 16. The mixture(s) may be stirred for between 1 and 12 hours, and at a temperature between 40° C. and 140° C.

The alkyl aluminium compound may have the formula AlRm wherein Rm is a radical component having 1 to 10 carbon atoms. The reaction is characterized by the absence of chlorine during the reaction.

Further, the catalyst may be prepolymerized according to the method described in the fourth aspect of the invention.

For the gas phase terpolymerization either a supported or prepolymerized catalyst may be used. The prepolymerized catalyst may be as hereinbefore described. The most preferred support is a terpolymer powder having the same composition as the terpolymer to be obtained in the terpolymerization, with this support being treated with the same alkyl aluminium as used as cocatalyst in the terpolymerization.

When the catalyst prepared according to this invention is used for the terpolymerization a cocatalyst may be used. The preferred cocatalysts have the formula AlRm wherein Rm is a radical component having 1 to 10 carbon atoms.

For a solution polymerization, the temperature of the process and the solvent will be selected such that the terpolymer is wholly soluble in the selected solvent during the terpolymerization.

The olefinic monomers employed in the terpolymerization according to this aspect of invention may also be obtained from the Fischer-Tropsch process as hereinbefore described in the fourth aspect of the invention; however any other polymerization grade olefinic monomers obtained from other processes may be employed instead of one or more of the olefinic monomers obtained from the Fischer-Tropsch process, as hereinbefore described.

Thus, in one embodiment of this aspect of the invention, the ethylene used as the first monomer may be obtained from a Fischer-Tropsch process.

In another embodiment of this aspect of the invention, the first branched alpha olefin may be the olefin obtained from a Fischer-Tropsch process, as hereinbefore described in respect of the fourth aspect of the invention.

The preferred branched olefins are 3-methyl-1-butene and 4-methyl-1pentene. However, a mixture of 4-methyl-1-pentene and 3-methyl-1-pentene is the most preferred.

In another embodiment of this aspect of the invention, both the branched olefins, may be obtained from a Fischer-Tropsch process. Preferred examples of such olefins have a carbon number between 4 and 9.

Typical examples of Fischer-Tropsch derived olefins which can be used are as hereibefore described in respect of the fourth aspect of the invention. An additional example of a suitable olefin is (percentages given on a mass basis):

A 1/1 Mixture of 4-methyl-1pentene and 3-methyl-1-pentene, which has a total of the other olefinic components of 2%, by mass.

In one embodiment of this aspect of the invention, ethylene may be copolymerized with 4-methyl-1-pentene as the first branched alpha olefin or second comonomer component and with a different second branched alpha olefin as the third comonomer component.

In a first version of this embodiment of this aspect of the invention, the third monomer may be 3-methyl-1-butene.

In a second version of this embodiment of this aspect of the invention, the third monomer may be 4-methyl-1-hexene.

In a third version of this embodiment of this aspect of the invention, the third monomer may be 3-methyl-1-pentene.

In another embodiment of this aspect of the invention, ethylene may be copolymerized with 3-methyl-1-butene as the first branched olefin or the second monomer component with a second different branched olefin or the third comonomer component.

The Applicant has also surprisingly found that the terpolymerization may be carried out by making use of the one or both of the comonomers as the reaction medium and introducing the ethylene into the reaction medium comprising the mixture of the two comonomers, or using ethylene and the second comonomer in a reaction medium consisting of the third monomer.

Thus, according to a sixth aspect of the invention, there is provided a process for polymerization of ethylene as a first monomer with a second branched monomer and a third monomer in a polymerization reaction, wherein at least one of the comonomers is used as a reaction medium or solvent during the polymerization reaction.

Thus, according to the sixth aspect of the invention, at least one of the comonomers is used as a reaction medium or solvent. The heat of the reaction may be removed by using classical heat exchanging facilities such as cooling mantles or cooling coils. However, the preferred method is by making use of the heat of evaporation of the monomeric reaction medium. Thus a controlled amount of the reaction medium monomer(s) may be evaporated, cooled externally in a heat exchanger and returned to the reaction vessel.

According to one embodiment of this aspect of the invention, one monomer is employed as the reaction medium.

According to a second embodiment of this aspect of the invention, a mixture of comonomers is used as the reaction medium.

The comonomers according to this aspect of the invention may be selected from the monomers hereinbefore set out in respect of the fourth and fifth aspects of the invention.

In one embodiment of this aspect of the invention ethylene as the first monomer is reacted with a branched alpha olefin as the second monomer and with a linear alpha olefin as the third comonomer.

In one version of this embodiment of this aspect of the invention the branched monomer may be the reaction medium or solvent.

In another version of this embodiment of this aspect of the invention the linear monomer may be the reaction medium or solvent.

In another version of this embodiment of this aspect of the invention both the linear monomer and the branched monomer may be the reaction medium or solvent.

In another embodiment of this aspect of the invention, ethylene as the first monomer is reacted with a branched alpha olefin as the second comonomer and with another branched alpha olefin as the third comonomer.

In one version of this embodiment of this aspect of the invention the first branched monomer may be the reaction medium or solvent.

In another version of this embodiment of this aspect of the invention the second branched monomer may be the reaction medium or solvent.

In another version of this embodiment of this aspect of the invention both the branched monomers may be the reaction medium or solvent.

The invention is now further illustrated by way of the following non-limiting examples.

In the examples, it has been indicated which monomers were Fischer-Tropsch derived. All monomers which are not indicated as being Fischer-Tropsch derived, were of so-called polymerization grade, ie of highest purity, such as defined in Aldrich Catelog Handbook of Fine Chemicals. These polymerization grade monomers were either obtained commercially, or by working up Fischer-Tropsch monomers.

In the Examples, all the percentages of the other olefinic components present in the second and/or the third components, are expressed on a mass basis.

### EXAMPLE 1

Catalyst A Preparation

In a 250 ml flask equipped with a reflux condenser and stirring facilities, were suspended 4 g of anhydrised magnesium chloride having a water content of 1,5%, in 60 ml highly purified heptane. Thereafter, 2 ml of ethanol and 1,4 ml of dibutyl ether were added, and the mixture stirred for 3 hours. 90 ml of a 10% triethyl aluminium solution in heptane were added drop wise to the flask to avoid excessive heat build-up, the resultant mixture ground to a smooth consistency, and allowed to cool to room temperature under stirring. The resultant slurry was then subjected to twelve washings using 50 ml heptane each time.

To the activated support thus formed, 2 ml of a 1:1:1 molar mixture of ethanol, 3-methyl-1-butanol and 2-methyl-1-pentanol were added, and the resultant slurry stirred for 3 hours. Thereafter, 20 ml of TiCl₄ in 100 ml heptane were added, and the mixture stirred under reflux for 60 minutes.

After cooling down, the slurry was subjected to ten washings using 50 ml heptane each time. After the final washing, the slurry was dried and pulverized to yield a pale yellow powdery catalyst.

### EXAMPLE 2

300 g of highly purified n-heptane were introduced into a 1 l stainless steel polymerization vessel provided with agitation. After a thorough purging of the vessel with nitrogen, 10 ml of triethylaluminium (10% solution in i heptane), and 0,1 g of catalyst A were introduced into the ago vessel. The temperature was set to 85° C. and 200 mg of hydrogen was introduced into the vessel. After 5 minutes, a simultaneous supply of ethylene at a constant flow rate of 10 g/min, and a 1:1 mass mixture of 3-methyl-1-butene and 1-pentene at a flow rate of 7 g/min was commenced. The monomer feed was stopped after 10 minutes and the reaction was continued for one hour.

After this reaction period, the polymerization vessel was depressurized and the catalyst decomposed with iso-propanol. The resultant copolymer was then filtered and repeatedly washed with propanol, and acetone. The terpolymer was dried in a vacuum oven at 70° C. for 24 hours. The yield of the terpolymer was 92 g.

The measured properties of the terpolymer were as follows:

MFI was 1 dg/min. measured according to ASTM D 1238. Density was 0.932 g/cc measured according to ASTM D 1505.

Hardness was 53 as measured according to ASTM D 2240.

Tensile strength at yield was 15.2 MPa as measured according to ASTM D 638M.

Elongation at yield was 83% as measured according to ASTM D 638M.

Modulus was 477 MPa measured according to ASTM D 638M.

Notched izod impact strength was 47,7 kJ/m² measured according to ASTM 256.

Composition: 2,5%

In the further examples given hereinafter, the various properties were measured using the same ASTM methods as used in Example 2. The composition is given as the sum of the molar percentages of the comonomers in the polymer, as determined by C¹³NMR. In the further examples given hereinafter, the composition is also given as the molar percentage of the comonomers, as measured by C¹³NMR.

### EXAMPLE 3

After a thorough purging of the vessel with nitrogen, 300 g of a 99:1 (mass basis) mixture of 3-methyl-1-butene and 4-methyl-1-pentene were introduced into the 1 l stainless steel polymerization vessel provided with agitation. 10 ml of triethylaluminium (10% solution in heptane), and 0,1 g of catalyst A were introduced into the vessel. The temperature was set to 85° C., and 200 mg of hydrogen were introduced into the vessel. After 5 minutes, a supply of ethylene at constant flow rate of log/min was commenced. The monomer feed was stopped after 10 minutes and the reaction was continued for one hour.

After this reaction period, the polymerization vessel was depressurized and the catalyst decomposed with iso-propanol. The resulant copolymer was then filtered and repeatedly washed with propanol, and acetone. The terpolymer was dried in a vacuum oven at 70° C. for 24 hours.

The measured properties of the terpolymer were as follows:

| | |
|---|---|
| Yield (g) | 80 |
| Density (g/cc) | 0.9195 |
| MFI (dg/min) | 2.1 |
| Hardness | 56 |
| Impact Strength (kJ/m²) | 51.2 |
| Yield Strength (MPa) | 16.1 |
| Elongation at Yield (%) | — |
| Young's Modulus (MPa) | 451 |
| Composition | 2.4% |

### EXAMPLE 4

After a thorough purging of the vessel with nitrogen, 300 g of a 50:50 (mass basis) mixture of 3-methyl-1-pentene and 4-methyl-1-pentene, were introduced into the 1 l stainless steel polymerization vessel provided with agitation. 10 ml of triethylaluminium (10% solution in heptane), and 0,1 g of catalyst A were introduced into the vessel. The temperature was set to 85° C., and 200 mg of hydrogen were introduced into the vessel. After 5 minutes, a supply of ethylene at a constant flow rate of 10 g/min was commenced. The monomer feed was stopped after 10 minutes and the reaction was continued for one hour.

After this reaction period, the polymerization vessel was depressurized and the catalyst decomposed with iso-propanol. The resultant copolymer was then filtered and repeatedly washed with propanol, and acetone. The terpolymer was dried in a vacuum oven at 70° C. for 24 hours.

The measured properties of the terpolymer were as follows:

| | |
|---|---|
| Yield (g) | 99 |
| Density (g/cc) | 0.9158 |
| MFI (dg/min) | 0.2 |
| Hardness | 48 |
| Impact Strength (kJ/m2) | 47.25 |
| Yield Strength (MPa) | 10.7 |
| Elongation at Yield (%) | 88 |
| Young's Modulus (MPa) | 297 |
| Composition (mole %) | 2.76 |

### EXAMPLE 5

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,1 g of catalyst A and 40 mg hydrogen. The following supplies to the autoclave were then started: ethylene at a continuous flow rate of 1 g/min, and a 50:50 (mass basis) mixture of 4-methyl-1-pentene, containing also 0,01% 3-methyl-1-pentene, and l-pentene, containing also 0,4% 2-methyl-1-butene, with both monomers having been obtained from a Fischer-Tropsch process, at a continuous flow rate of 0,3 g/min. These supplies were continued until 100 g of ethylene had been added. Both the ethylene and the other comonomer flows were then stopped 240 and the reaction continued for another 20 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 72 |
| Density (g/cc) | 0.923 |
| MFI (dg/min) | 1.3 |
| Hardness | 46 |
| Impact Strength (kJ/m²) | 42 |
| Yield Strength (MPa) | 11.3 |
| Elongation at Yield (%) | 79 |
| Young's Modulus (MPa) | 324 |
| Composition (mole %) | 4.08 |

### EXAMPLE 6

300 g of highly purified n-heptane were introduced into a if stainless steel polymerization vessel provided with agitation. After a thorough purging of the vessel with nitrogen, 10 ml of triethylaluminium (10% solution in heptane), and 0,1 g of catalyst A were introduced into the vessel. The temperature was set to 85° C. and 200 mg of hydrogen was introduced into the vessel. After 5 minutes, a simultaneous supply of ethylene at a constant flow rate of 10 g/min, and a 1:1 (mass basis) mixture of 4-methyl-1-pentene and 1-pentene at a flow rate of 4 g/min was commenced. The monomer feed was stopped after 10 minutes and the reaction was continued for one hour.

After this reaction period, the polymerization vessel was depressurized and the catalyst decomposed with iso-propanol. The resultant copolymer was then filtered and repeatedly washed with propanol, and acetone. The terpolymer was dried in a vacuum oven at 70° C. for 24 hours.

The measured properties of the terpolymer were as follows:

| | |
|---|---|
| Yield (g) | 82 |
| Density (g/cc) | 0.918 |
| MFI (dg/min) | 0.4 |
| Hardness | 46 |
| Young's Modulus (MPa) | 320 |
| Composition (mole %) | 4.99 |

### EXAMPLE 7

300 g of highly purified n-heptane were introduced into a 1 l stainless steel polymerization vessel provided with agitation. After a thorough purging of the vessel with nitrogen, 10 ml of triethylaluminium (10% solution in heptane), and 0,1 g of catalyst A were introduced into the vessel. The temperature was set to 85° C., and 200 mg of hydrogen were introduced into the vessel. After 5 minutes, a simultaneous supply of ethylene at a constant flow rate of 10 g/min, and a 1:1 (mass basis) mixture of 3-methyl-1-pentene and 4-methyl-1-pentene, at a flow rate of 5 g/min was commenced. The monomer feed was stopped after 10 minutes, and the reaction was continued for one hour.

After this reaction period, the polymerization vessel was depressurized and the catalyst decomposed with iso-propanol. The resultant copolymer was then filtered and repeatedly washed with propanol, and acetone. The terpolymer was dried in a vacuum oven at 70° C. for 24 hours.

The measured properties of the terpolymer were as follows:

| | |
|---|---|
| Yield (g) | 92 |
| Density (g/cc) | 0.9185 |
| MFI (dg/min) | 5 |
| Hardness | 46 |
| Impact Strength (kJ/m²) | 39.6 |
| Yield Strength (MPa) | 10.3 |
| Elongation at Yield (%) | 61 |
| Young's Modulus (MPa) | 336 |
| Composition (mole %) | 6.44 |

### EXAMPLE 8

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,1 g of catalyst A and 35 mg hydrogen. The following supplies to the autoclave were then started: ethylene at a continuous flow rate of 1 g/min, and a 50:50 (mass basis) mixture of 4-methyl-1-pentene and 3-methyl-1-pentene, at a continuous flow of 0,4 g/min. These supplies were continued until 100 g of ethylene had been added. Both the ethylene and the other comonomer flows were then stopped and the reaction continued for another 20 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 75 |
| Density (g/cc) | 0.925 |
| MFI (dg/min) | 1.8 |
| Hardness | 50 |
| Impact Strength (kJ/m²) | 41.9 |
| Yield Strength (MPa) | 12.1 |
| Elongation at Yield (%) | 84 |
| Young's Modulus (MPa) | 338 |

### EXAMPLE 9

Catalyst B Preparation

In a 250 ml flask equipped with a reflux condenser and stirring facilities, were suspended 20 g of anhydrised magnesium chloride having a water content of 1,5%, in 150 ml highly purified heptane. Thereafter, 40 ml of dipentyl ether were added and the resultant slurry refluxed for 3 hours. The slurry was then filtered and washed with heptane until no ether could be detected in the washings. The solid material thus obtained was stirred in the presence of 100 ml of a 10% solution of triethyl aluminium in heptane for 24 hours, ground to a smooth consistency and then washed with heptane until no triethyl aluminium could be detected in the washings. 20 ml of a 1:1 (molar basis) mixture of ethanol and 3-methyl-1-butanol were added, the mixture stirred for 3 days and then again washed 10 times with 100 ml heptane each time. This material was ground in the presence of 150 ml TiCl₄ and 100 ml heptane at room temperature until a smooth consistency solid was obtained. The temperature was increased to 100° C. and stirred for 1 hour after which it was cooled and washed with heptane until no more TiCl₄ could be detected in the washings.

### EXAMPLE 10

Catalyst C Preparation

In a 250 ml flask equipped with a reflux condenser and stirring facilities, were suspended 20 g of anhydrised magnesium chloride having a water content of 1,5% in 150 ml highly purified heptane. Thereafter, 40 ml of dipentyl ether were added and the resultant slurry refluxed for 3 hours. The slurry was then filtered and washed with heptane until no ether could be detected in the washings. The solid material thus obtained was stirred in the presence of 100 ml of a 10% solution of triethyl aluminium for 24 hours, filtered and then washed with heptane until no triethyl aluminium could be detected in the washings. 20 ml of a 1:1 (molar basis) mixture of ethanol and 2-methyl-1-pentanol were added, the mixture stirred for 3 days and then again washed 10 times with 100 ml heptane each time. This material was ground in the presence of 150 ml TiCl₄ and 100 ml heptane at room temperature until a smooth consistency solid was obtained. The temperature was increased to 100° C. and stirred for 1 hour after which it was cooled and washed with heptane until no more TiCl₄ could be detected in the washings.

### EXAMPLE 11

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution was added 0,2 g of catalyst B and 50 mg hydrogen and the mixture stirred for another 5 minutes to form the activated catalyst. The following supplies to the autoclave were then started: ethylene at a continuous flow rate of 4 g/min, and a 30/70 (mass basis) mixture of propylene and 3-methyl-1-butene, containing also 0,005% 2-methyl-1-butene, with both monomers having been obtained from a Fischer-Tropsch process, at a continuous flow rate of 1 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 123 |
| Density (g/cc) | 0,915 |
| MFI (dg/min) | 2,4 |
| Hardness | 47 |
| Impact Strength (kJ/m²) | 37,1 |
| Yield Strength (MPa) | 10,9 |
| Elongation at Yield (%) | 57 |
| Young's Modulus (MPa) | 327 |
| Composition | 4,0% |

### EXAMPLE 12

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 50/50 (mass basis) mixture of propylene and 3-methyl-1-butene, containing also 0,01% 2-methyl-2-butene, with both monomers having been obtained from a Fischer-Tropsch process, at a continuous flow rate of 2 g/min. These supplies were continued until 50 g of ethylene had been added. Both the ethylene and the other comonomer flows were then stopped and the reaction continued for another 48 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 66 |
| Density (g/cc) | 0,921 |
| MFI (dg/min) | 5,6 |
| Hardness | 40 |
| Impact Strength (kJ/m²) | 30,1 |
| Yield Strength (MPa) | 9,4 |
| Elongation at Yield (%) | 37 |
| Young's Modulus (MPa) | 300 |
| Composition (mole %) | 5,17 |

### EXAMPLE 13

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 15/85 (mass basis) mixture of 1-nonene, containing also 0,01% 2-methyl-1-octene, obtained from a Fischer-Tropsch process and 3-methyl-1-butene at a 41-5 continuous flow rate of 1 g/min. These supplies were continued until 100 g of ethylene had been added. Both the -ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 121 |
| Density (g/cc) | 0,92 |
| MFI (dg/min) | 9,5 |
| Hardness | 43 |
| Impact Strength (kJ/m²) | 24,2 |
| Yield Strength (MPa) | 10,2 |
| Elongation at Yield (%) | 41 |
| Young's Modulus (MPa) | 403 |
| Composition | 4,2% |

### EXAMPLE 14

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 70/30 (mass basis) mixture of 1-butene and 3-methyl-1-butene, containing also 0,01% 2methyl-2-butyl, obtained from a Fischer-Tropsch process, at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 mg of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 143 |
| Density (g/cc) | 0,903 |
| MFI (dg/min) | 7,8 |
| Hardness | 28 |
| Impact Strength (kJ/m²) | 22,4 |
| Yield Strength (MPa) | 5,6 |
| Elongation at Yield (%) | 144 |
| Young's Modulus (MPa) | 199 |
| Composition | 7,5% |

### EXAMPLE 15

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started; ethylene at a continuous flow rate of 4 g/min and a 30/70 (mass basis) mixture of 1-hexene, containing also 0,5% 2-methyl-1-pentene and 0,2% 2-methyl-2-pentene, and 3-methyl-1-butene, containing also 0,5% 2-methyl-2-butene, with both monomers having been obtained from a Fischer-Tropsch process, at a continuous flow rate of 1 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 117 |
| Density (g/cc) | 0,922 |
| MFI (dg/min) | 1,9 |
| Hardness | 49 |
| Impact Strength (kJ/m²) | 43,3 |
| Yield Strength (MPa) | 12,5 |
| Elongation at Yield (%) | 50 |
| Young's Modulus (MPa) | 404 |
| Composition | 3,7% |

### EXAMPLE 16

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 30/70 (mass basis) mixture of 1-hexene and 3-methyl-1-butene at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 141 |
| Density (g/cc) | 0,840 |
| MFI (dg/min) | 22,6 |
| Hardness | 10 |
| Impact Strength (kJ/m²) | 10 |
| Yield Strength (MPa) | 1,7 |
| Elongation at Yield (%) | 74 |
| Young's Modulus (MPa) | 52 |
| Composition (mole %) | 10,58 |

### EXAMPLE 17

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 70/30 (mass basis) mixture of 1decene and 3-methyl-1-butene, containing also 0,5% 2-methyl-2-butene, obtained from a Fischer-Tropsch process, at a continuous flow rate of 2 g/min. These supplies were continued until 100 g of ethylene was added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 140 |
| Density (g/cc) | 0,922 |
| MFI (dg/min) | 1,9 |
| Hardness | 46 |
| Impact Strength (kJ/m²) | 30,6 |
| Yield Strength (MPa) | 13,3 |
| Elongation at Yield (%) | 52 |
| Young's Modulus (MPa) | 347 |
| Composition | 3,9% |

### EXAMPLE 18

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 30/70 (mass basis) mixture of 1-heptene, containing also 1% 2-methyl-2-hexene, and 3-methyl-1-butene, containing also 0,01% 2-methyl-2-butene, with both monomers having been obtained from a Fischer-Tropsch process, at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 140 |
| Density (g/cc) | 0,925 |
| MFI (dg/min) | 2,9 |
| Hardness | 51 |
| Impact Strength (kJ/m²) | 28,3 |
| Yield Strength (MPa) | 12,9 |
| Elongation at Yield (%) | 48 |
| Young's Modulus (MPa) | 406 |
| Composition | 3,6% |

### EXAMPLE 19

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The folowing supplies to the autoclave were then started: ethylene at a continuous flow rate of 4 g/min and a 30/70 (mass basis) mixture of propylene and 4-methyl-1-pentene, containing also 1% 3-methyl-1-pentene, obtained from a Fischer-Tropsch process, at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 144 |
| Density (g/cc) | 0,895 |
| MFI (dg/min) | 7,7 |
| Hardness | 31 |
| Impact Strength (kJ/m²) | 22,3 |
| Yield Strength (MPa) | 6,6 |
| Elongation at Yield (%) | 61 |
| Young's Modulus (MPa) | 305 |
| Composition (mole %) | 8,15 |

### EXAMPLE 20

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 3 g/min and a 50/50 (mass basis) mixture of propylene and 4-methyl-1-pentene, at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 119 |
| Density (g/cc) | 0,876 |
| MFI (dg/min) | 11 |
| Hardness | 23 |
| Impact Strength (kJ/m²) | 17,6 |
| Yield Strength (MPa) | 5,0 |
| Elongation at Yield (%) | 76 |
| Young's Modulus (MPa) | 142 |
| Composition | 8,7% |

### EXAMPLE 21

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min and a 50/50 (mass basis) mixture of propylene and 4-methyl-1-pentene, containing also 2% 3-methyl-1-pentene, with both monomers having been obtained from a Fischer-Tropsch process, at a continuous flow rate of 1 g/min. These supplies were continued until 100 g of -ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 125 |
| Density (g/cc) | 0.920 |
| MFI (dg/min) | 5.4 |
| Hardness | 42 |
| Impact Strength (kJ/m²) | 30.4 |
| Yield Strength (MPa) | 9.6 |
| Elongation at Yield (%) | 45.3 |
| Young's Modulus (MPa) | 353 |
| Composition | 7.6% |

### EXAMPLE 22

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min and a 30/70 (mass basis) mixture of 1-octene and 4-methyl-1-pentene, at a continuous flow rate of 2 g/min. The supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 145 |
| Density (g/cc) | 0.915 |
| MFI (dg/min) | 2.0 |
| Hardness | 42 |
| Impact Strength (kJ/m²) | 39.5 |
| Yield Strength (MPa) | 9.5 |
| Elongation at Yield (%) | 57 |
| Young's Modulus (MPa) | 293 |
| Composition | 4.5% |

### EXAMPLE 23

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min and a 50/50 (mass basis) mixture of 1-octene and 4-methyl-1-pentene, containing also 2% 3-methyl-1-pentene, obtained from a Fischer-Tropsch process, at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 145 |
| Density (g/cc) | 0.918 |
| MFI (dg/min) | 2.1 |
| Hardness | 44 |
| Impact Strength (kJ/m²) | 40.8 |
| Yield Strength (MPa) | 10.8 |
| Elongation at Yield (%) | 50 |
| Young's Modulus (MPa) | 334 |
| Composition (mole %) | 3.22 |

### EXAMPLE 24

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 70/30 (mass basis) mixture of 1-octene containing also 0,4% 3-methyl-2-heptene, and 4-methyl-1-pentene, containing also 2% 3-methyl-1-pentene, with both monomers having been obtained from a Fischer-Tropsch process, at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 145 |
| Density (g/cc) | 0.914 |
| MFI (dg/min) | 4.5 |
| Hardness | 33 |
| Impact Strength (kJ/m²) | 31.5 |
| Yield Strength (MPa) | 7.8 |
| Elongation at Yield (%) | 65 |
| Young's Modulus (MPa) | 204 |
| Composition | 7% |

### EXAMPLE 25

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 30/70 (mass basis) mixture of 1-butene and 4-methyl-1-pentene, containing also 1% 3-methyl-1-pentene, obtained from a Fischer-Tropsch process, at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 148 |
| Density (g/cc) | 0.916 |
| MFI (dg/min) | 5.4 |
| Hardness | 39 |
| Impact Strength (kJ/m²) | 34.1 |
| Yield Strength (MPa) | 8.4 |
| Elongation at Yield (%) | 56 |
| Young's Modulus (MPa) | 269 |
| Composition | 6.1% |

### EXAMPLE 26

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane weres added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 50/50 (mass basis) mixture of 1-butene and 4-methyl-1-pentene, containing also 0,5% 3-methyl-1-pentene, with both monomers having been obtained from a Fischer-Tropsch process, at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 138 |
| Density (g/cc) | 0.890 |
| MFI (dg/min) | 6.0 |
| Hardness | 28 |
| Impact Strength (kJ/m²) | 22.8 |
| Yield Strength (MPa) | 6.4 |
| Elongation at Yield (%) | 100 |
| Young's Modulus (MPa) | 195 |
| Composition (mole %) | 8.29 |

### EXAMPLE 27

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 70/30 (mass basis) mixture of 1-nonene, containing also 0,01% 2-methyl-1-octene, and 4-methyl-1-pentene, containing also 0,5% 3-methyl-1-pentene, with both monomers having been obtained from a Fischer-Tropsch process, at a continuous flow rate of 1 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 122 |
| Density (g/cc) | 0.914 |
| MFI (dg/mm) | 0.75 |
| Hardness | 42 |
| Impact Strength (kJ/m²) | 38.5 |
| Yield Strength (MPa) | 14.9 |
| Elongation at Yield (%) | 90 |
| Young's Modulus (MPa) | 274 |
| Composition | 5.1% |

### EXAMPLE 28

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system.

To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 70/30 (mass basis) mixture of 1-heptene, containing also 1% 2-methyl-2-hexene, and 4-methyl-1-pentene, containing also 2% 3-methyl-1-pentene, with both monomers having been obtained from a Fischer-Tropsch process, at a continuous flow rate of 0,2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 105 |
| Density (g/cc) | 0.938 |
| MFI (dg/min) | 0.9 |
| Hardness | 58 |
| Impact Strength (kJ/m²) | 16.9 |
| Yield Strength (MPa) | 21.3 |
| Elongation at Yield (%) | 50 |
| Young's Modulus (MPa) | 622 |

### EXAMPLE 29

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min and a 30/70 (mass basis) mixture of 1-hexene and-4-methyl-1-pentene at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 150 |
| Density (g/cc) | 0.906 |
| MFI (dg/min) | 3.9 |
| Hardness | 42 |
| Impact Strength (kJ/m²) | 31.8 |
| Yield Strength (MPa) | 8.8 |
| Elongation at Yield (%) | 47 |
| Young's Modulus (MPa) | 352 |
| Composition | 4.3% |

### EXAMPLE 30

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autocoave were then started: ethylene at a continuous flow rate of 4 g/min, and a 50/50 (mass basis) mixture of 1-hexene and 4-methyl-1-pentene, containing also 1% 3-methyl-1-pentene, obtained from a Fischer-Tropsch process, at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 150 |
| Density (g/cc) | 0.909 |
| MFI (dg/min) | 4.4 |
| Hardness | 37 |
| Impact Strength (kJ/m²) | 32.2 |
| Yield Szrength (MPa) | 8.2 |
| Elongation at Yield (%) | 58 |
| Young's Modulus (MPa) | 253 |
| Composition | 6.2% |

### EXAMPLE 31

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 70/30 (mass basis) mixture of 1-hexene, containing also 0,5% 2-methyl-1-pentene and 0,2% 2-methyl-2-pentene, and 4-methyl-1-pentene, containing also 0,5% 3-methyl-1-pentene, with both monomers having been obtained from a Fischer-Tropsch process, at a continuous flow rate of 1 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 120 |
| Density (g/cc) | 0.918 |
| MFI (dg/min) | 1.2 |
| Hardness | 48 |
| Impact Strength (kJ/m²) | 44.8 |
| Yield Strength (MPa) | 12.4 |
| Elongation at Yield (%) | 53 |
| Young's Modulus (MPa) | 364 |
| Composition | 4.6% |

### EXAMPLE 32

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min, and a 70/30 (mass basis) mixture of 1-decene and 4-methyl-1-pentene, containing also 0,5% 3-methyl-1-pentene, obtained from a Fischer-Tropsch process, at a continuous flow rate of 2 g/min. These supplies were continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 143 |
| Density (g/cc) | 0.835 |
| MFI (dg/min) | 27 |
| Hardness | 5 |
| Impact Strength (kJ/m²) | 11.5 |
| Yield Strength (MPa) | 1.5 |
| Elongation at Yield (%) | 34 |
| Young's Modulus (MPa) | 103 |
| Composition (mole %) | 12.67 |

### EXAMPLE 33

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autocoave were than started: ethylene at a continuous flow rate of 4 g/min and a 30/70 (mass basis) mixture of 1-decene and 4-methyl-1-pentene at a continuous flow rate of 2 g/min. These supplies were continued until 100 g of ethylene had been added. Both the ethylene and comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 150 |
| Density (g/cc) | 0.869 |
| MFI (dg/min) | 14.9 |
| Hardness | 20 |
| Impact Strength (kJ/m²) | 16.3 |
| Yield Strength (MPa) | 3.3 |
| Elongation at Yield (%) | 56 |
| Young's Modulus (MPa) | 174 |
| Composition (mole %) | 6.56 |

### EXAMPLE 34

Catalyst D Preparation

Prepolymerization

To a 1000 ml stainless steel autoclave fitted with an external filtering device, thoroughly flushed with high purity nitrogen, 350 g of purified heptane were added and the temperature set at 80° C. When the correct temperature had been reached, 100 ml of a 10% solution of triethyl aluminium in heptane were added and stirred for 5 minutes to react with residual impurities in the system. To this solution were added 2 g of catalyst B and 50 mg hydrogen, and the mixture stirred for another 5 minutes to form the activated catalyst. The following supplies to the autocoave were then started: ethylene at a continuous flow rate of 20 g/min and a 50/50 (mass basis) mixture of 3-methyl-1-pentene and 4-methyl-pentene, with both monomers having been obtained from a Fischer-Tropsch process, at a continuous flow rate of 10 g/min. These supplies were continued until 50 g of ethylene had been added. Both the ethylene and the other comonomer flows were then stopped and the solid prepolymerized catalyst separated from the liquid medium by means of the external filter. The prepolymerized catalyst was washed twice with heptane, sealed in the filtering device which was then removed from the reactor and transferred to a glovebox having an inert atmosphere where the prepolymerized catalyst was transferred to a storage container after drying.

### EXAMPLE 35

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,5 g of prepolymerized catalyst D and 30 mg hydrogen. The following supplies to the autocoave were than started: ethylene at a continuous flow rate of 2 g/min, and a 25/75 (mass basis) mixture of 3-methyl-1-pentene and 4-methyl-1-pentene, containing also 1 l 2,3-di-methyl-1-butene, with both monomers having been obtained from a Fischer-Tropsch process, at a continuous flow rate of 08 g/min. These supplies were continued until 100 g of ethylene had been added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 81 |
| Density (g/cc) | 0.935 |
| MFI (dg/min) | 0.04 |
| Hardness | 56 |
| Impact Strength (kJ/m²) | 59.4 |
| Yield Strength (MPa) | 22.2 |
| Elongation at Yield (%) | 92 |
| Young's Modulus (MPa) | 566 |
| Composition | 7.0% |

### EXAMPLE 36

To a 1000 mg stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,5 g of prepolymerized catalyst D and 50 mg hydrogen. The following supplies to the autoclave were then started: ethylene at a continuous flow rate of 2 g/min and a 10/90 (mass basis) mixture of 3-methyl-1-pentene and 4-methyl-1-pentene, containing also 1% 2,3-di-methyl-1-butene, with both monomers having been obtained from a Fischer-Tropsch process, at a continuous flow rate of 0,8 g/min. These supplies were continued until 100 g of ethylene had been added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 85 |
| Density (g/cc) | 0.939 |
| MFI (dg/min) | 0.9 |
| Hardness | 56 |
| Impact Strength (kJ/m²) | 60.6 |
| Yield Strength (MPa) | 25.2 |
| Elongation at Yield (%) | 104 |
| Young's Modulus (MPa) | 553 |
| Composition | 2.1% |

### EXAMPLE 37

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,5 g of prepolymerized catalyst D and 100 mg hydrogen. The following supplies to the autoclave were then started: ethylene at a continuous flow rate of 2 g/min and a 15/85 (mass basis) mixture of 3-methyl-1-pentene and 4-methyl-1-pentene, containing also 2% 2,3-di-methyl-1-butene, with both monomers having been obtained from a Fischer-Tropsch process, at a continuous flow rate of 1 g/min. These supplies were continued until 100 g of ethylene had been added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined and then injection-moulded for measurement of some mechanical and physical properties. The results obtained were as follows:

| | |
|---|---|
| Yield (g) | 59 |
| Density (g/cc) | 0.9414 |
| MFI (dg/min) | 0.6 |
| Hardness | 58 |
| Impact Strength (kJ/m²) | 33.8 |
| Yield Strength (MPa) | 18.3 |
| Elongation at Yield (%) | 44 |
| Young's Modulus (MPa) | 584 |
| Composition | 1.7% |

### EXAMPLE 38

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,5 g of prepolymerized catalyst D and 100 mg hydrogen. The following supplies to the autocoave were then started: ethylene at a continuous flow rate of 2 g/min and a 20/80 (mass basis) mixture of 3-methyl-1-pentene and 4-methyl-1-pentene, containing also 1,5% 2,3-di-methyl-1-butene, with both monomers having been obtained from a Fischer-Tropsch process, at a continuous flow rate of 1 g/min. These supplies were continued until 100 g of ethylene had been added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 51 |
| Density (g/cc) | 0.942 |
| MFI (dg/min) | 0.26 |
| Hardness | 59 |
| Impact Strength (kJ/m²) | 47.6 |
| Yield Strength (MPa) | 20.8 |
| Elongation at Yield (%) | 47 |
| Young's Modulus (MPa) | 618 |
| Composition | 1.65% |

### EXAMPLE 39

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,5 g of prepolymerized catalyst D and 150 mg hydrogen. The following supplies to the autoclave were then started: ethylene at a continuous flow rate of 2 g/min and a 30/70 (mass basis) mixture of 3-methyl-1-pentene and 4-methyl-1-pentene, containing also 1,5% 2,3-di-methyl-1-butene, with both monomers having been obtained from a Fischer-Tropsch process, at a continuous flow rate of 1 g/min. These supplies were continued until 100 g of ethylene was added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 53 |
| Density (g/cc) | 0.943 |
| MFI (dg/min) | 0.6 |
| Hardness | 57 |
| Impact Strength (kJ/m²) | 38.0 |
| Yield Strength (MPa) | 18.3 |
| Elongation at Yield (%) | 48 |
| Young's Modulus (MPa) | 564 |
| Composition | 1.6% |

### EXAMPLE 40

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,5 g of prepolymerized catalyst D and 120 mg hydrogen. The following supplies to the autoclave were then started: ethylene at a continuous flow rate of 2 g/min and a 40/60 (mass basis) mixture of 3-methyl-1-pentene and 4-methyl-1-pentene, containing also 1,5% 2,3-di-methyl-1-butene, with the monomers having been obtained from a Fischer-Tropsch process, at a continuous flow rate of 1 g/min. These supplies were continued until 100 g of ethylene was added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 55 |
| Density (g/cc) | 0.942 |
| MFI (dg/min) | 0.3 |
| Hardness | 62 |
| Impact Strength (kJ/m²) | 42.7 |
| Yield Strength (MPa) | 31.5 |
| Elongation at Yield (%) | 62 |
| Young's Modulus (MPa) | 727 |
| Composition | 1.6% |

### EXAMPLE 41

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,5 g of prepolymerized catalyst D and 150 mg hydrogen. The following supplies to the autoclave were then started: ethylene at a continuous flow rate of 2 g/min and a 50/50 (mass basis) mixture of 3-methyl-1-pentene and 4-methyl-1-pentene, containing also 0,5% 2,3-di-methyl-1-butene, with both monomers having been obtained from a Fischer-Tropsch process, at a continuous flow rate of 1 g/min. These supplies were continued until 100 g of ethylene had been added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 54 |
| Density (g/cc) | 0.920 |
| MFI (dg/min) | 0.6 |
| Hardness | 49 |
| Impact Strength (kJ/m²) | 21.5 |
| Yield Strength (MPa) | — |
| Elongation at Yield (%) | — |
| Young's Modulus (MPa) | — |
| Composition | 3.4% |

### EXAMPLE 42

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,5 g of prepolymerized catalyst D and 150 mg hydrogen. The following supplies to the autoclave were then started: ethylene at a continuous flow rate of 2 g/min and a 50/50 (mass basis) mixture of 4-methyl-1-pentene and 1-pentene, containing also 0,46% 2-methyl-1-butene, obtained from a Fischer-Tropsch process, at a continuous flow rate of ig/min. These supplies were continued until 100 g of ethylene had been added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 58 |
| Density (g/cc) | 0.924 |
| MFI (dg/min) | 0.6 |
| Hardness | 50 |
| Impact Strength (kJ/m²) | 27.1 |
| Yield Strength (MPa) | — |
| Elongation at Yield (%) | — |
| Young's Modulus (MPa) | — |
| Composition | 3.4% |

### EXAMPLE 43

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,5 g of prepolymerized catalyst D and 150 mg hydrogen. The following supplies to the autoclave were then started: ethylene at a continuous flow rate of 2 g/min and a 70/30 (mass basis) mixture of 4-methyl-1-pentene and 1-hexene at a continuous flow rate of 1 g/min. These supplies were continued until 100 g of ethylene had been added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 59 |
| Density (g/cc) | 0.941 |
| MFI (dg/min) | 0.8 |
| Hardness | — |
| Impact Strength (kJ/m²) | — |
| Yield Strength (MPa) | — |
| Elongation at Yield (%) | — |
| Young's Modulus (MPa) | — |
| Composition | 7.1% |

### EXAMPLE 44

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,1 g of catalyst C and 150 mg hydrogen and the mixture stirred for 5 minutes to form the active catalyst. The following supplies to the autoclave were then started: ethylene at a continuous flow rate of 2 g/min and a 10/90 (mass basis) mixture of 3-methyl-1-pentene and 4-methyl-1-pentene, containing also 0,5% 2,3-di-methyl-1-butene, with both monomers having been obtained from a Fischer-Tropsch process, at a continuous flow rate of 3,4 g/min. These supplies were continued until 100 g of ethylene had been added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 69 |
| Density (g/cc) | 0.905 |
| MFI (dg/min) | 8.6 |
| Hardness | 32 |
| Impact Strength (kJ/m²) | 27.0 |
| Yield Strength (MPa) | 4.8 |
| Elongation at Yield (%) | 55 |
| Young's Modulus (MPa) | 272 |
| Composition (mole %) | 7.94 |

### EXAMPLE 45

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,1 g of catalyst C and 150 mg hydrogen and the mixture stirred for 5 minutes to form the active catalyst. The following supplies to the autoclave were then started: ethylene at a continuous flow rate of 2 g/min and a 20/80 (mass basis) mixture of 3-methyl-1-pentene and 4-methyl-1-pentene, containing also 1% 2,3-di-methyl-1-butene, with both monomers having been obtained from a Fischer-Tropsch process, at a continuous flow rate of 6 g/min. These supplies were continued until 100 g of ethylene had been added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 109 |
| Density (g/cc) | 0.915 |
| MFI (dg/min) | 7.5 |
| Hardness | 41 |
| Impact Strength (kJ/m²) | 34.4 |
| Yield Strength (MPa) | 8.2 |
| Elongation at Yield (%) | 110 |
| Young's Modulus (MPa) | 207 |
| Composition (mole %) | 6.02 |

### EXAMPLE 46

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,1 g of catalyst C and 150 mg hydrogen, and the mixture stirred for 5 minutes to form the active catalyst. The following supplies to the autoclave were then started: ethylene at a continuous flow rate of 2 g/min and a 30/70 (mass basis) mixture of 3-methyl-1-pentene and 4-methyl-1-pentene, containing also 2% 2,3-di-methyl-1-butene, with both monomers having been obtained from a Fischer-Tropsch process, at a continuous flow rate of 6 g/min. These supplies were continued until 100 g of ethylene had been added. Both the ethylene and the other comonomer flows were then stopped and the reaction continued for another 10 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 96 |
| Density (g/cc) | 0.916 |
| MFI (dg/min) | 1.8 |
| Hardness | 48 |
| Impact Strength (kJ/m²) | 41.2 |
| Yield Strength (MPa) | 11.1 |
| Elongation at Yield (%) | 89 |
| Young's Modulus (MPa) | 343 |
| Composition (mole %) | 3.03 |

### EXAMPLE 47

To a 1000 ml stainless steel autoclave, thoroughly flushed with high purity nitrogen, 300 g of purified heptane were added and the temperature set at 85° C. When the correct temperature had been reached, 10 ml of a 10% solution of triethyl aluminium in heptane were added and stirred for 5 minutes to react with residual impurities in the system. To this solution were added 0,1 g of catalyst C and 150 mg hydrogen, and the mixture stirred for 5 minutes to form the active catalyst. The following supplies tot he autoclave were then started: ethylene at a continuous flow rate of 2 g/min and a 40/60 (mass basis) mixture of 3-methyl-1-pentene and 4-methyl-1-pentene, containing also 1,5% 2,3-di-methyl-1-butene, with both monomers having been obtained from a Fischer-Tropsch process, at a continuous flow rate of 6 g/min. These supplies were continued until 100 g of ethylene was added. Both the ethylene and the other comonomer flows were then stopped and the reaction continued for another 10 minutes after which the reactor 2 l was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 107 |
| Density (g/cc) | 0.916 |
| MFI (dg/min) | 0.001 |
| Hardness | 48 |
| Impact Strength (kJ/m²) | 46.6 |
| Yield Strength (MPa) | 11.3 |
| Elongation at Yield (%) | 101 |
| Young's Modulus (MPa) | 321 |
| Composition (mole %) | 3.44 |

### EXAMPLE 48

To a 1000 ml stainless steel autoclave, thoroughly flushed with high purity nitrogen, 350 g of purified heptane were added and the temperature set at 80° C. When the correct temperature had been reached, 10 ml of a 10% solution of triethyl aluminium in heptane were added and stirred for 5 minutes to react with residual impurities in the system. To this solution were added 0,2 g of catalyst B and 50 mg hydrogen, and the mixture stirred for another 5 minutes to form the activated catalyst. The following supplies to the autoclave were then started: ethylene at a continuous flow rate of 4 g/min and a 50/50 (mass basis) mixture of 1-octene, containing also 0,4% 3-methyl-2-heptane, and 3-methyl-1-butene, with both monomers having been obtained from a Fischer-Tropsch process, at a continuous flow rate of 2 g/min. These supplies wer continued until 100 g of ethylene had been added. Both the ethylene and the other comonomer flows were then stopped and the reaction continued for another 35 minutes after which the reactor was depressurized and the reaction terminated by the addition of 100 ml of iso-propanol. The resulting slurry was filtered, washed with acetone and dried. The polymer was weighed, its melt flow index determined, and then injection-moulded for measurement of some mechanical and physical properties. The results obtained were as follows:

| | |
|---|---|
| Yield (g) | 143 |
| Density (g/cc) | 0.920 |
| MFI (dg/min) | 2.9 |
| Hardness | 49 |
| Impact Strength (kJ/m²) | 39.8 |
| Yield Strength (MPa) | 9.9 |
| Elongation at Yield (%) | 53 |
| Young's Modulus (MPa) | 380 |
| Composition | 4.2% |

1. A polymer of ethylene as a first component or monomer, with a branched alpha olefin as a second component or monomer and at least one different alpha olefin as a third component or monomer, and wherein at least one of the co-monomers is Fischer-Tropsch derived.

2. A polymer which is the reaction product of ethylene as a first component or monomer with a branched alpha olefin as a second component or monomer and at least one different alpha olefin as a third component or monomer, and wherein at least one of the co-monomers is Fischer-Tropsch derived.

3. A terpolymer of ethylene as a first component or monomer with a branched alpha olefin as a second component or monomer and at least one different alpha olefin as a third component or monomer, and wherein at least one of the co-monomers is Fischer-Tropsch derived.

4. A polymer according to any one of claims 1 to 3 inclusive, wherein the branched alpha olefin is Fischer-Tropsch derived.

5. A polymer according to any one of claims 1 to 3 inclusive, wherein the different alpha olefin is Fischer-Tropsch derived.

6. A polymer according to any one of claims 1 to 3 inclusive, wherein both the branched alpha olefin and the different alpha olefin are Fischer-Tropsch derived.

7. A polymer according to any one of claims 1 to 6 inclusive, wherein the ethylene is Fischer-Tropsch derived.

8. A polymer according to any one of claims 1 to 7 inclusive, wherein the ratio of the molar proportion of the ethylene to the sum of the molar proportions of the branched alpha olefin and the different alpha olefin is between 99,9:0,1 and 80:20.

9. A polymer according to claim 8, wherein the ratio of the molar proportion of the ethylene to the sum of the molar proportions of the branched alpha olefin and the different alpha olefin is between 99,9:0,1 and 90:10.

10. A polymer according to claim 9, wherein the molar proportion of the ethylene to the sum of the molar proportions of the branched alpha olefin and the different alpha olefin is between 99,9:0,1 and 95:5.

11. A polymer according to any one of claims 1 to 10 inclusive, wherein the ratio of the molar proportion of the branched alpha olefin to that of the different alpha olefin is between 0,1:99,9 and 99,9:0,1.

12. A polymer according to claim 11, wherein the ratio of the molar proportion of the branched alpha olefin to that of the different alpha olefin is between 1:99 and 99:1.

13. A polymer according to claim 12, wherein the molar proportion of the branched alpha olefin to that of the different alpha olefin is between 2:98 and 98:2.

14. A polymer according to any one of claims 1 to 13 inclusive, which is obtained by reacting ethylene, the branched alpha olefin and the different alpha olefin in one or more reaction zones, while maintaining in the reaction zone(s) a pressure in the range between atmospheric pressure and 5000 kg/cm² and a temperature between ambient and 300° C., in the presence of a suitable catalyst or catalyst system.

15. A polymer according to any one of claims 1 to 14 inclusive, wherein the third component is a linear alpha olefin.

16. A polymer of ethylene as a first component or monomer with at least one branched alpha olefin as a second component or monomer and at least one linear alpha olefin as a third component or monomer, and which has the following properties:
a) a melt flow rate as measured according to ASTM D 1238 in the range of 0,01 to about 100 g/10 min; and/or
b) a density as measured according to ASTM D 1505 in the range of about 0,835 to about 0,950; and/or
c) when its hardness is plotted against its density, it conforms to the following equation:
545,4ρ−463,64<H<545,4ρ−447,3
where ρ is the density of the polymer as measured according to ASTM D 1505 and H is the hardness of the polymer as measured according to ASTM D 2240, with the domain for which the equation is valid being:
0<H<60
and
0,82<ρ<0,96

17. A polymer which is the reaction product of ethylene as a first component or monomer with at least one branched alpha olefin as a second component or monomer and at least one linear alpha olefin as a third component or monomer, and which has the following properties:
a) a melt flow rate as measured according to ASTM D 1238 in the range of 0,01 to about 100 g/10 min; and/or
b) a density as measured according to ASTM D 1505 in the range of about 0,835 to about 0,950; and/or
c) when its hardness is plotted against its density, it conforms to the following equation:
545,4ρ−463,64<H<545,4ρ−447,3
where ρ is the density of the polymer as measured according to ASTM D 1505 and H is the hardness of the polymer as measured according to ASTM D 2240, with the domain for which the equation is valid being:
0<H<60
and
0,82<ρ<0,96

18. A terpolymer of ethylene as a first component or monomer with at least one branched alpha olefin as a second component or monomer and at least one linear alpha olefin as a third component or monomer, and which has the following properties:
a) a melt flow rate as measured according to ASTM D 1238 in the range of 0,01 to about 100 g/10 min; and/or
b) a density as measured according to ASTM D 1505 in the range of about 0,835 to about 0,950; and/or
c) when its hardness is plotted against its density, it conforms to the following equation:
545,4ρ−463,64<H<545,4ρ−447,3
where ρ is the density of the polymer as measured according to ASTM D 1505 and H is the hardness of the polymer as measured according to ASTM D 2240, with the domain for which the equation is valid being:
0<H<60
and
0,82<ρ<0,96

19. A polymer according to claim 15, which has the following properties:
a) a melt flow rate as measured according to ASTM D 1238 in the range of 0,01 to about 100 g/10 min; and/or
b) a density as measured according to ASTM D 1505 in the range of about 0,835 to about 0,950; and/or
c) when its hardness is plotted against its density, it conforms to the following equation:
545,4ρ−463,64<H<545,4ρ−447,3
where ρ is the density of the polymer as measured according to ASTM D 1505 and H is the hardness of the polymer as measured according to ASTM D 2240, with the domain for which the equation is valid being:
0<H<60
and
0,82<ρ<0,96

20. A polymer according to any one of claims 15 to 19 inclusive, wherein the branched alpha olefin is 4-methyl-1-pentene.

21. A polymer according to claim 20, which has the following properties:
a) a melt flow rate as measured according to ASTM D 1238 in the range of 0,01 to about 10 g/10 min; and/or
b) a density as measured according to ASTM D 1505 in the range of about 0,890 to about 0,950; and/or
c) when its tensile strength at yield is plotted against its density, it conforms to the following equation:
σ>111,1ρ−93,3
where ρ is the density of the polymer as measured according to ASTM D 1505 and a is its tensile strength at yield as measured according to ASTM D 638 M, with the domain for which the equation is valid being:
σ>0
and
0,84<ρ<0,96;
and/or
d) when its modulus is plotted against its density, it conforms to the following equation:
E>3636ρ−3090,9
where ρ is the density of the terpolymer as measured according to ASTM D 1505 and E is its modulus as measured according to ASTM D 638 M, with the domain for which the equation is valid being:
E>0
and
0,85<ρ<0,96

22. A polymer according to claim 20 or claim 21, wherein the third component is propylene.

23. A polymer according to claim 20 or claim 21, wherein the third component is 1-butene.

24. A polymer according to claim 20 or claim 21, wherein the third component is 1-pentene.

25. A polymer according to claim 20 or claim 21, wherein the third component is 1-hexene.

26. A polymer according to claim 20 or claim 21, wherein the third component is 1-heptene.

27. A polymer according to claim 20 or claim 21, wherein the third component is 1-octene.

28. A polymer according to claim 20 or claim 21, wherein the third component is 1-nonene.

29. A polymer according to claim 20 or claim 21, wherein the third component is 1-decene.

30. A polymer according to any one of claims 15 to 19 inclusive, wherein the branched alpha olefin is 3-methyl-1-butene.

31. A polymer according to claim 30 which has the following properties:
a) a melt flow rate as measured according to ti ASTM D 1238 in the range of 0,01 to about 100 g/10 min; and/or
b) a density as measured according to ASTM D 1505 in the range of about 0,835 to about 0,950; and/or
c) when its tensile strength at yield is plotted against its density, it conforms to the following equation:
σ>111,11ρ−95,56
where ρ is the density of the terpolymer as measured according to ASTM D 1505 and a is its tensile strength at yield as measured according to ASTM D 638 M, with the domain for which the equation is valid being:
σ>0
and
0,86<ρ<0,96;
and/or
d) when its modulus is plotted against its density, it conforms to the following equation:
E>5555,56ρ−4833,3
where ρ is the density of the terpolymer as measured according to ASTM D 1505 and E is the modulus as measured according to ASTM D 638 M and the domain for which the equation is valid being:
E>0
and
0,87<σ<0,96

32. A terpolymer according to claim 30 or claim 31, wherein the third component is propylene.

33. A polymer according to claim 30 or claim 31, wherein the third component is 1-butene.

34. A polymer according to claim 30 or claim 31, wherein the third component is 1-pentene.

35. A polymer according to claim 30 or claim 31, wherein the third component is 1-hexene.

36. A polymer according to claim 30 or claim 31, wherein the third component is 1-heptene.

37. A polymer according to claim 30 or claim 31, wherein the third component is 1-octene.

38. A polymer according to claim 30 or claim 31, wherein the third component is 1-nonene.

39. A polymer according to claim 30 or claim 31, wherein the third component is 1-decene.

40. A polymer according to any one of claims 1 to 14 inclusive, wherein the third component is a branched alpha olefin which is different to that of the second component.

41. A polymer of ethylene as a first component or monomer, with at least one branched alpha olefin as a second component or monomer and at least one different branched alpha olefin as a third component or monomer.

42. A polymer which is the reaction product of ethylene as a first component or monomer with at least one branched alpha olefin as a second component or monomer and at least one different branched alpha olefin as a third component or monomer.

43. A terpolymer of ethylene as a first component or monomer with a branched alpha olefin as a second component or monomer and a different branched alpha olefin as a third component or monomer.

44. A polymer of ethylene with at least two different branched alpha olefins.

45. A polymer according co any one of claims 40 to 44 inclusive, which is a terpolymer of ethylene with 4-methyl-1-pentene as the or a second component and 3-methyl-1-pentene as the or a third component.

46. A polymer according to any one of claims 40 to 45 inclusive, which has the following properties:
a) a melt flow rate as measured according to ASTM D 1238 in the range of 0,01 to about 100 g/10 min; and/or
b) a density as measured according to ASTM D 1505 in the range of about 0,890 to about 0,950; and/or
c) when its tensile strength is plotted against its density, it conforms to the following equation:
σ>240ρ−212,4
where ρ is the density of the terpolymer as measured according to ASTM D 1505 and a is its tensile strength at yield as measured according to ASTM D 638 M, with the domain for which the equation is valid being:
σ>0
and
0,885<ρ<0,96;
and/or
d) when its modulus is plotted against its density, it conforms to the following equation:
E>700/0,06σ−10500
where ρ is the density of the terpolymer as measured according to ASTM D 1505 and E is its modulus as measured according to ASTM D 638 M, with the domain for which the equation is valid being:
E>0
and
0,9<ρ<0,96;
and/or
e) when its impact strength is plotted against its density, it conforms to the following equation:
I>150ρ−109
where ρ is the density of the polymer as measured according to ASTM D 1505 and I is its impact strength as measured according to ASTM D 256 M, with the domain for which the equation is valid being:
I>20
and
0,86<ρ<0,943

47. A polymer according to any one of claims 40 to 44 inclusive, wherein one of the branched alpha olefins is 4-methyl-1-pentene.

48. A polymer according to any one of claims 40 to 44 inclusive, wherein one of the branched alpha olefins is 3-methyl-1-butene.

49. A process for producing a polymer, which process comprises reacting at least ethylene as a first component or monomer, with a branched alpha olefin as a second component or monomer, and with a linear alpha olefin as a third component or monomer, in one or more reaction zones, while maintaining the reaction zone(s) at a pressure between atmospheric pressure and 5000 kg/cm²₁ and at a temperature between ambient and 300° C., in the presence of a particular catalyst or a catalyst system comprising a particular catalyst and a cocatalyst.

50. A process according to claim 49, wherein the linear alpha olefin and the branched alpha olefin are added simultaneously at the start of the reaction, while the ethylene is added continuously during the course of the reaction.

51. A process according to claim 49, wherein either the linear alpha olefin or the branched alpha olefin are added at the start of the reaction while ethylene is added continuously during the reaction, with a continuous or discontinuous supply of the monomer which was not added at the beginning of the reaction being provided, and with no product being removed during the reaction.

52. A process according to claim 49, wherein the reaction is effected in a continuous fashion, with the ethylene being added continuously, and with the linear alpha olefin and the branched alpha olefin being added together and continuously during the course of the reaction.

53. A process according to claim 49, wherein the reaction is effected in a continuous fashion, with the ethylene being added continuously, and with the linear alpha olefin and the branched alpha olefin being added separately and continuously during the course of the reaction.

54. A process according to claim 49, wherein the reaction is effected in a continuous fashion, with the ethylene being added continuously, and with the linear alpha olefin and the branched alpha olefin being added together but discontinuously during the course of the reaction.

55. A process according to claim 49, wherein the reaction is effected in a continuous fashion, with the ethylene being added continuously, and with the linear alpha olefin and the branched olefin being added separately and discontinuously during the course of the reaction.

56. A process for producing a polymer, which process comprises reacting at least ethylene as a first component or monomer, a branched alpha olefin as a second component or monomer, and a linear alpha olefin as a third component or monomer in one or more reaction zones, while maintaining the reaction zone(s) at a pressure between atmospheric pressure and 5000 kg/cm², and at a temperature between ambient and 300° C., in the presence of a particular catalyst, or a catalyst system comprising a particular catalyst and a cocatalyst, with the particular catalyst being that obtained by:
i) suspending partially anhydrous magnesium chloride in a highly purified hydrocarbon solvent to obtain a magnesium chloride slurry;
ii) adding to the slurry at least one alcohol and one ether and stirring the mixture for a period of time to obtain a partially activated magnesium chloride;
iii) adding thereto, in drop wise fashion, an alkyl aluminium compound, with the resultant mixture being ground to a smooth consistency and thereafter cooled to room temperature to obtain an activated magnesium chloride;
iv) washing the activated magnesium chloride with a highly purified hydrocarbon solvent to obtain a washed activated magnesium chloride, which constitutes the support of the catalyst;
v) adding a mixture of alcohols to the washed support, followed by stirring, to obtain an alcohol loaded support;
vi) adding titanium tetrachloride to the alcohol loaded support and stirring the resultant mixture under reflux for a period of time to obtain a titanium loaded catalyst; and
vii) cooling and then washing the titanium loaded catalyst with a highly purified hydrocarbon solvent, followed by drying and pulverising thereof to obtain the catalyst.

57. A process according to claim 56, wherein the magnesium chloride is partially anhydrised and has a water content between 0,02 mole of water/mole of magnesium chloride and 2 mole of water/mole of magnesium chloride.

58. A process according to claim 56 or claim 57, wherein the ether is selected from linear ethers having a total number of carbon atoms between 8 and 16, and the alcohol(s) is (are) selected from the range of alcohols having 2 to 8 carbon atoms.

59. A process according to any one of claims 56 to 58 inclusive, wherein the mixtures are stirred for between 1 and 12 hours, and at a temperature between 40° C. and 140° C.

60. A process according to any one of claims 56 to 59 inclusive, wherein the alkyl aluminium compound has the formula AlRm wherein Rm is a radical component having 1 to 10 carbon atoms, and with no chlorine being present.

61. A process for producing a polymer, which process comprises reacting at least ethylene as a first component or monomer, with a branched alpha olefin as a second component or monomer, and with a linear alpha olefin as a third component or monomer, in one or more reaction zones, while maintaining the reaction zone(s) at a pressure between atmospheric pressure and 5000 kg/cm²₁ and at a temperature between ambient and 300° C., in the presence of a particular catalyst, or a catalyst system comprising a particular catalyst and a cocatalyst, with the particular catalyst being that obtained by:
i) suspending partially anhydrous magnesium chloride in a highly purified hydrocarbon solvent to obtain a magnesium chloride slurry;
ii) adding to the slurry at least one ether and stirring the mixture for a period of time to obtain a partially activated magnesium chloride;
iii) filtering and washing the partially activated magnesium chloride slurry with a highly purified hydrocarbon solvent until no ether is detected in the washing liquid, to obtain a washed partially activated magnesium chloride;
iv) adding thereto, in drop wise fashion, an alkyl aluminium compound followed by grinding to a smooth consistency and cooling to room temperature, to obtain an activated magnesium chloride;
v) washing the activated magnesium chloride with a highly purified hydrocarbon solvent until no alkyl aluminium is detected in the washing liquid, to obtain a washed activated magnesium chloride, which constitutes the support of the catalyst;
vi) adding a mixture of alcohols to the washed support, followed by stirring, to obtain an alcohol loaded support;
vii) washing the alcohol loaded support with a highly purified hydrocarbon solvent, to obtain a washed alcohol loaded support;
viii) adding titanium tetrachloride to the washed alcohol loaded support, and grinding it to a smooth consistency to obtain a titanium loaded catalyst; and
ix) washing the titanium loaded catalyst with a highly purified hydrocarbon solvent until no titanium is detected in the washing liquid, to obtain the catalyst.

62. A process for producing a polymer, which process comprises reacting at least ethylene as a first component or monomer, with a branched alpha olefin as a second component or monomer and with a linear alpha olefin as a third component or monomer, in one or more reaction zones, while maintaining the reaction zone(s) at a pressure between atmospheric pressure and 5000 kg/cm², and at a temperature between ambient and 300° C., in the presence of a particular catalyst, or a catalyst system comprising a particular catalyst and a cocatalyst, wherein the catalyst has been prepolymerized with an alpha olefin having 2 to 8 carbon atoms or with a mixture of alpha olefins having 2 to 8 carbon atoms, and wherein the amount of polymer which results from the prepolymerization is in the range of 1 to 500 polymer/g of catalyst.

63. A process according to claim 62, wherein the prepolymerization is performed with the same monomers as are reacted in the process.

64. A process according to claim 62 or claim 63, wherein the prepolymerization includes the following steps:
i) adding, in a closed vessel under inert conditions, an amount of 1 to 10 weight % of the trialkyl aluminium compound under stirring to a highly purified hydrocarbon solvent at about 80° C., to obtain a liquid mixture;
ii) adding an amount of 0,1-1 weight % of the catalyst to the liquid mixture;
iii) adding an amount of less than 0,5 weight 6 of hydrogen to the closed vessel;
iv) continuously supplying the monomers separately or as a mixture, until a desired increase of weight is achieved corresponding to a desired polymer/catalyst ratio; and
v) filtering the resultant prepolymerized catalyst and washing it with a hydrocarbon solvent, followed by another filtration step and subsequent drying thereof.

65. A process according to any one of claims 49 to 65 inclusive, wherein at least one of the components or monomers is Fischer-Tropsch derived.

66. A process according to claim 65, wherein the ethylene is Fischer-Tropsch derived.

67. A process according to claim 65 or claim 66, wherein the branched alpha olefin is Fischer-Tropsch derived.

68. A process according to any one of claims 65 to 67 inclusive, wherein the second monomer is 4-methyl-1-pentene.

69. A process according to claim 68, wherein the linear alpha olefin has a total number of carbon atoms between 3 and 10.

70. A process according to any one of claims 65 to 67 inclusive, wherein the second monomer is 3-methyl-1-butene.

71. A process according to claim 70, wherein the linear alpha olefin has a total number of carbon atoms between 3 and 10.

72. A process for producing a terpolymer, which process comprises reacting ethylene, a first branched alpha olefin and a second different branched alpha olefin in one or more reaction zones, while maintaining the reaction zone(s) at a pressure between atmospheric pressure and 5000 kg/cm², and at a temperature between ambient and 300° C., in the presence of a particular catalyst, or a catalyst system comprising a particular catalyst and a cocatalyst.

73. A process according to claim 72, wherein the it first and second branched alpha olefins are added simultaneously at the start of the reaction, while the ethylene is added continuously during the course of the reaction.

74. A process according to claim 72, wherein either the first branched alpha olefin or the second branched alpha olefin is added at the start of the reaction while ethylene is added continuously during the reaction and with the other of the first or second branched olefin which was not added at the start being supplied continuously or discontinuously.

75. A process according to claim 72, wherein the reaction is effected in a continuous fashion, with the ethylene being added continuously, and with the first branched alpha olefin and the second branched alpha olefin being added together and continuously during the course of the reaction.

76. A process according to claim 72, wherein the reaction is effected in a continuous fashion, with the ethylene being added continuously, and with the first branched alpha olefin and the second branched alpha olefin being added separately and continuously during the course of the reaction.

77. A process according to claim 72, wherein the reaction is effected in a continuous fashion, with the ethylene being added continuously, and with the first branched alpha olefin and the second branched alpha olefin being added together and discontinuously during the course of the reaction.

78. A process according to claim 72, wherein the reaction is effected in a continuous fashion, with the ethylene being added continuously, and with the first branched alpha olefin and the second branched alpha olefin being added separately but discontinuously, during the course of the reaction.

79. A process for producing a polymer, which process comprises reacting at least ethylene as a first component or monomer, with a branched alpha olefin as a second component or monomer and with a different branched alpha olefin as a third component or monomer, in one or more reaction zones, while maintaining the reaction zone(s) at a pressure between atmospheric pressure and 5000 kg/cm², and at a temperature between ambient and 300° C., in the presence of a particular catalyst, or a catalyst system comprising a particular catalyst and a cocatalyst, wherein the particular catalyst is that obtained by:
i) suspending partially anhydrous magnesium chloride in a highly purified hydrocarbon solvent to obtain a magnesium chloride slurry;
ii) adding to the slurry at least one alcohol and one ether, and stirring the mixture for a period of time to obtain a partially activated magnesium chloride;
iii) adding thereto, in drop wise fashion, an alkyl aluminium component, with the resultant mixture being ground to a smooth consistency, and thereafter cooled to room temperature, to obtain an activated magnesium chloride;
iv) washing the activated magnesium chloride with a highly purified hydrocarbon solvent to obtain a washed activated magnesium chloride, which constitutes the support of the catalyst;
v) adding a mixture of alcohols to the washed support, followed by stirring, to obtain an alcohol loaded support;
vi) adding titanium tetrachloride to the alcohol loaded support and stirring the resultant mixture under reflux for a period of time to obtain a titanium loaded catalyst; and
vii) cooling and then washing the titanium loaded catalyst with a highly purified hydrocarbon solvent, followed by drying and pulverising to obtain the catalyst.

80. A process according to claim 79, wherein the magnesium chloride is partially anhydrised and has a water content between 0,02 mole of water/mole of magnesium chloride and 2 mole of water/mole of magnesium chloride.

81. A process according to claim 79 or claim 80, wherein the ether is selected from linear ethers having a total number of carbon atoms between 8 and 16.

82. A process according to any one of claims 79 to 81 inclusive, wherein the alkyl aluminium compound has the formula AlRm wherein Rm is a radical component having 1 to 10 carbon atoms, and with no chlorine being present.

83. A process for producing a polymer, which process comprises reacting at least ethylene as a first component or monomer, with a branched alpha olefin as a second component or monomer and with a different branched alpha olefin as a third component or monomer in one or more reaction zones, while maintaining the reaction zone(s) at a pressure between atmospheric pressure and 5000 kg/cm², and at a temperature between ambient and 300° C., in the presence of a particular catalyst, or a catalyst system comprising a particular catalyst and a cocatalyst, with the particular catalyst being that obtained by:
i) suspending partially anhydrous magnesium chloride in a highly purified hydrocarbon solvent to obtain a magnesium chloride slurry;
ii) adding to the slurry at least one ether and stirring the mixture for a period of time to obtain a partially activated magnesium chloride;
iii) filtering and washing the partially activated magnesium chloride slurry with a highly purified hydrocarbon solvent until no ether is detected in the washing liquid, to obtain a washed partially activated magnesium chloride;
iv) adding thereto, in drop wise fashion, an alkyl aluminium compound followed by grinding to a smooth consistency and cooling to room temperature, to obtain an activated magnesium chloride;
v) washing the activated magnesium chloride with a highly purified hydrocarbon solvent until no alkyl aluminium is detected in the washing liquid, to obtain a washed activated magnesium chloride, which constitutes the support of the catalyst;
vi) adding a mixture of alcohols to the washed support, followed by stirring, to obtain an alcohol loaded support;
vii) washing the alcohol loaded support with a highly purified hydrocarbon solvent, to obtain a washed alcohol loaded support;
viii) adding titanium tetrachloride to the washed alcohol loaded support, and grinding it to a smooth consistency to obtain a titanium loaded catalyst; and
ix) washing the titanium loaded catalyst with a highly purified hydrocarbon solvent until no titanium is detected in the washing liquid, to obtain the catalyst.

84. A process for producing a polymer which comprises reacting at least ethylene as a first component or monomer, with a branched alpha olefin as a second component or monomer, and with a different branched alpha olefin as a third component or monomer, in one or more reaction zones, while maintaining the reaction zone(s) at a pressure between atmospheric pressure and 5000 kg/cm²₁ and at a temperature between ambient and 300° C., in the presence of a particular catalyst, or a catalyst system comprising a particular catalyst and a cocatalyst, with the particular catalyst being that obtained by:
i) suspending partially anhydrous magnesium chloride in a highly purified hydrocarbon solvent to obtain a magnesium chloride slurry;
ii) adding to the slurry at least one ether and stirring the mixture for a period of time to obtain a partially activated magnesium chloride;
iii) washing the partially activated magnesium chloride with a highly purified hydrocarbon solvent until no ether is detected in the washing liquid, to obtain a washed partially activated magnesium chloride;
iv) adding thereto, in drop wise fashion, an alkyl aluminium compound under stirring, and cooling to room temperature, to obtain an activated magnesium chloride;
v) washing the activated magnesium chloride with a highly purified hydrocarbon solvent until no alkyl aluminium is detected in the washing liquid, to obtain a washed activated magnesium chloride, which constitutes the support of the catalyst;
vi) adding a mixture of alcohols to the washed support, followed by stirring, to obtain an alcohol loaded support;
vii) washing the alcohol loaded support with a highly purified hydrocarbon solvent, to obtain a washed alcohol loaded support;
viii) adding titanium tetrachloride to the washed alcohol loaded support, and grinding it to a smooth consistency to obtain a titanium loaded catalyst; and
ix) washing the titanium loaded catalyst with a highly purified hydrocarbon solvent until no titanium is detected in the washing liquid, to obtain the catalyst.

85. A process for producing a polymer, which process comprises reacting at least ethylene as a first component or monomer, with a branched alpha olefin as a second component or monomer and with a different branched alpha olefin as a third component or monomer in one or more reaction zones, while maintaining the reaction zone(s) at a pressure between atmospheric pressure and 5000 kg/cm², and at a temperature between ambient and 300° C., in the presence of a particular catalyst, or a catalyst system comprising a particular catalyst and a cocatalyst, wherein the catalyst has been prepolymerized with an alpha olefin having 2 to 8 carbon atoms or with a mixture of alpha olefins having 2 to 8 carbon atoms, and wherein the amount of polymer which results from the prepolymerization is in the range of 1 to 500 polymer/g of catalyst.

86. A process according to claim 85, wherein the prepolymerization is performed with the same monomers as are reacted in the process.

87. A process according to claim 85 or claim 86, wherein the prepolymerization includes the following steps:
i) adding, in a closed vessel under inert conditions, an amount of 1 to 10 weight % of the trialkyl aluminium compound under stirring to a highly purified hydrocarbon solvent at about 80° C., to obtain a liquid mixture;
ii) adding an amount of 0,1-1 weight % of the catalyst to the liquid mixture;
iii) adding an amount of less than 0,5 weight % of hydrogen to the closed vessel;
iv) continuously supplying the monomers separately or as a mixture, until a desired increase of weight is achieved corresponding to a desired polymer/catalyst ratio; and
v) filtering the resultant prepolymerized catalyst and washing it with a hydrocarbon solvent, followed by another filtration step and subsequent drying thereof.

88. A process according to any one of claims 72 to 87 inclusive, wherein at least one of the components or monomers is Fischer-Tropsch derived.

89. A process according to claim 88, wherein the ethylene is Fischer-Tropsch derived.

90. A process according to claim 88 or claim 89, wherein the second component or monomer is Fischer-Tropsch derived.

91. A process according to claim 88 or claim 89, wherein the third component or monomer is Fischer-Tropsch derived.

92. A process according to claim 88 or claim 89, wherein both the second and the third components or monomers are Fischer-Tropsch derived.

93. A process according to any one of claims 72 to 92 inclusive, wherein the second component or monomer is 4-methyl-1-pentene.

94. A process according to any one of claims 72 to 92 inclusive, wherein the second component or monomer is 3-methyl-1-butene.

95. A process according to any one of claims 72 to 94 inclusive, wherein the third component or monomer is 3-methyl-1-pentene.

96. A process for polymerization of ethylene as a first monomer with a second branched monomer and a third monomer in a polymerization reaction, wherein at least one of the comonomers is used as a reaction medium or solvent during the polymerization reaction.
